(19) United States
(12) Patent Application Publication
(10) Pub. No.: US 2026/0208891 A1
(43) Pub. Date: Jul. 23, 2026

(54) AERIAL VEHICLE AND AERIAL VEHICLE SYSTEMS

(71) Applicant: Zipline International Inc., South San Francisco, CA (US)

(72) Inventors: Zoltan Laszlo, Pacifica, CA (US); Eric Chrisman, Sacramento, CA (US); Brian Boomgaard, Half Moon Bay, CA (US); Gustavo Eidji Camarinha Fujiwara, Oakland, CA (US); Keenan Wyrobek, Half Moon Bay, CA (US); Kevin Nalecz, San Francisco, CA (US); Brendan Doyle Wade, San Francisco, CA (US); Sven Blaser, Brisbane, CA (US); Kevin Durand, San Bruno, CA (US); Frederik Nielsen, San Francisco, CA (US); Elliot Owen, Menlo Park, CA (US); Karl Skeel, San Francisco, CA (US)

(21) Appl. No.: 19/157,748

(22) PCT Filed: Feb. 28, 2024
(86) PCT No.: PCT/US2024/017632

§ 371 Date: Aug. 19, 2025

Related U.S. Application Data
(60) Provisional application No. 63/449,536, filed on Mar. 2, 2023.

(51) Int. Cl. B64U 40/10; B64C 27/26; B64U 10/10; B64U 10/25; B64U 30/29; B64U 30/40; B64U 101/64

(52) U.S. Cl. CPC B64U 40/10; B64C 27/26; B64U 10/10; B64U 10/25; B64U 30/29; B64U 30/40; B64U 2101/64

(57) ABSTRACT

Various examples of an aerial vehicle and/or aerial vehicle system are disclosed. In one example, an aerial vehicle is disclosed including a fuselage and a plurality of propellers coupled to the fuselage to define a lift pentagram. The lift pentagram is positioned such that a center of gravity of the aerial vehicle is positioned within the lift pentagram.

### CROSS REFERENCE TO RELATED APPLICATIONS

This application claims the benefit of U.S. Provisional Application No. 63/449,536, filed Mar. 2, 2023, the disclosure of which is incorporated by reference in its entirety.

This application is related to International Patent Application No. PCT/US2024/016087, filed on Feb. 16, 2024, and titled “Docking Configurations for Aerial Vehicles,” and International Patent Application No. ______ (Attorney Docket No. P308478.WO.01), filed on ______ and titled “Autonomous Delivery Vehicle and System,” both of which are incorporated by reference in their entireties.

### FIELD

The described embodiments relate generally to aerial vehicles, aerial vehicle systems, and components thereof.

### BACKGROUND

Aerial vehicles, such as airplanes and unmanned vehicles (drones), have many uses. Recently, aerial vehicles are becoming a viable option for package delivery vehicles. Such aerial vehicles can take many forms, such as, but not limited to, rotorcraft (e.g., helicopters, quadrotors, and so on) as well as fixed-wing aircraft. As aerial vehicles are used more frequently for package deliveries, there is a need for improved overall systems that allow safe and reliable flight operations, smooth and pleasant delivery experiences for customers, reduced noise, as well as energy efficiency. As such, there is a need for improved aerial vehicles, systems of delivery, and various components thereof.

### SUMMARY

In one example, an aerial vehicle is disclosed that includes a fuselage and a plurality of propellers coupled to the fuselage to define a lift pentagram, where the lift pentagram is positioned such that a center of gravity of the aerial vehicle is positioned within the lift pentagram. Each propeller of the plurality of propellers may define a lift point for the lift pentagram. The plurality of propellers and the center of gravity of the aerial vehicle may be configured to enable the center of gravity of the aerial vehicle to remain within an adjusted lift geometry upon a fault for one of the propellers of the plurality of propellers. A first forward propeller and a second forward propeller of the plurality of propellers may be spaced apart by a first distance. A first rear propeller and a second rear propeller of the plurality of propellers may be spaced apart by a second distance, wherein the second distance is larger than the first distance. The aerial vehicle may include a tail propeller, wherein the lift pentagram is defined by a center of lift generated by the first forward propeller, the second forward propeller, the first rear propeller, the second rear propeller, and the tail propeller. The tail propeller may be movable relative to the fuselage for at least one of counteracting a loss of one of the first forward propeller, the second forward propeller, the first rear propeller, or the second rear propeller; or maintaining a stability in transitioning between a hover mode and a cruise mode. The tail propeller may be movable along at least two axes. The aerial vehicle may include a plurality of booms coupled to the fuselage, wherein the plurality of propellers are coupled to respective booms of the plurality of booms. A first boom and a second boom of the plurality of booms may extend towards a front of the fuselage and curve inwards towards the fuselage along a length. A third boom and a fourth boom of the plurality of booms may extend towards a rear of the fuselage and are angled away from a center of the fuselage.

In one example, an aerial vehicle is disclosed that includes a fuselage and a propeller assembly, where the propeller assembly includes a propeller and a boom coupled to the fuselage and the propeller, where the boom curves along a length thereof. The aerial vehicle may include a first wing extending from a first side of the fuselage and a second wing extending from a second side of the fuselage, wherein the boom is coupled to the first wing and curves towards the fuselage and extends away from the first wing. The propeller may be a first propeller and the boom may be a first boom, with the aerial vehicle including a second propeller and a second boom. The first boom may extend from a first wing towards a front of the fuselage and curves towards the fuselage. The second boom may extend from a second wing towards the front end of the fuselage. The aerial vehicle may include a third boom coupled to the first wing and extending towards a rear of the fuselage, and a fourth boom coupled to the second wing and extending towards the rear of the fuselage. The aerial vehicle may include a third propeller coupled to the third boom and a fourth propeller coupled to the fourth boom. A rotational axis of the first propeller and a rotational axis of the third propeller may be spaced apart by different distances from the fuselage. The propeller may be a wing propeller and is coupled to the fuselage via a wing, and the aerial vehicle further comprises a tail propeller coupled to a rear of the fuselage.

In one example, an aerial vehicle is disclosed that includes a fuselage, a wing assembly coupled to the fuselage, and a propeller assembly coupled to the fuselage and spaced apart from the wing assembly. The propeller assembly may include a propeller and a mounting assembly, there the mounting assembly or orientation assembly moves the propeller between a first position relative to the fuselage and a second position relative to the fuselage. The mounting assembly may move the propeller to the first position for a forward flight motion and to the second position for a hovering flight motion. The mounting assembly may move the propeller to the second position to counteract environmental forces experienced on the aerial vehicle. The mounting assembly may move the propeller along a first axis and a second axis different from the first axis. The mounting assembly may include a first motor to move the propeller along the first axis, and a second motor to move the propeller along the second axis. The mounting assembly may move the propeller along a path, wherein at a first location on the path the propeller is arranged at a first yaw and a first pitch and at a second location on the path the propeller is arranged at a second yaw and a second pitch.

In one example, an aerial vehicle is disclosed that includes a dynamically positionable propeller configured to be positioned at two or more positions in order to counteract forces experienced by the vehicle during flight. A force experienced by the aerial vehicle may include a force vector due to a failure of a static propeller.

In one example, a method of controlling an aerial vehicle is disclosed. The method includes dynamically positioning a force vector for the aerial vehicle via a movable propeller to dynamically control the aerial vehicle in both hover and forward flight. Dynamically positioning the force vector may include adjusting to account for wind direction, wind gusts, and/or drive failures of the aerial vehicle. The method may include dynamically positioning the force vector for the aerial vehicle to maintain a level configuration of the aerial vehicle during a transition between a hover and forward flight.

In one example, an aerial vehicle system is disclosed that includes a first aerial vehicle having a first center of gravity and a second aerial vehicle coupled to the first aerial vehicle and configured to be deployed from the first aerial vehicle, the second aerial vehicle having a second center of gravity, where the first center of gravity and the second center of gravity are within a stability bound for the aerial vehicle. The stability bound may be defined by points of lift generated by the first aerial vehicle. The points of lift may be arranged in a pentagram configuration. The stability bound may be defined for flight in a forward configuration and flight in a hover configuration. The aerial vehicle system may include a tether coupling the first aerial vehicle to the second aerial vehicle, wherein a spooling point of the tether is aligned with the second center of gravity. In a first configuration, the second aerial vehicle may form a portion of a bottom surface of the second aerial vehicle. The first aerial vehicle may include a docking portion configured to be received with a dock, wherein the docking portion is aligned with the first center of gravity. The second aerial vehicle may be configured to receive a payload and position the payload such that a payload center of gravity aligns with the first center of gravity. The first aerial vehicle may include a set of forward propeller booms extending towards a front end of the first aerial vehicle and having a first length, and a set of rear propeller booms extending towards a rear end of the first aerial vehicle and having a second length that is shorter than the first length.

In one example, an aerial vehicle is disclosed that includes a fuselage including a monolithically formed chassis and a wing coupled to the fuselage that includes a first wing extending from a first side of the fuselage and a second wing extending from a second side of the fuselage. The chassis may include a first wing portion and a second wing portion, wherein the first wing is coupled to the first wing portion and the second wing is coupled to the second wing portion. The aerial vehicle may include a first propeller boom and a second propeller boom, wherein the first propeller boom and the second propeller boom form a portion of the chassis. The aerial vehicle may include a third propeller boom and a fourth propeller boom, wherein the third propeller boom and the fourth propeller form a portion of the chassis. An end of the first propeller boom and an end of the second propeller boom may be spaced apart by a first distance and an end of the third propeller boom and an end of the fourth propeller boom may be spaced apart by a second distance less than the first distance. The fuselage may include a foam coupled to and extending over a portion of the chassis.

In one example, an aerial vehicle is disclosed that includes a fuselage including an integrally formed chassis and a boom coupled to the fuselage and formed integrally with the chassis. The chassis may be at least partially hollow. The chassis may include one or more coupling interfaces configured to receive fasteners to couple components to the fuselage.

In one example, a motor assembly for an aerial vehicle is disclosed. The motor assembly includes a planetary gear assembly including a sun gear and a plurality of planet gears coupled thereto, a first electrical component positioned on a first side of the planetary gear assembly, a second electrical component positioned on a second side of the planetary gear assembly, and a wire electrically coupling the first electrical component to the second electrical component, where the wire extends through the sun gear. The second electrical component may be a motor. The motor assembly may include a gear mount, wherein the gear mount defines a gear shaft, wherein the sun gear is received around the gear shaft and the wire extends through gear shaft.

In one example, an aerial vehicle is disclosed that includes a fuselage, a sensor coupled to the fuselage, and a cleaning assembly coupled to the sensor and configured to direct an air stream over a portion of the sensor. The sensor may be a camera and the portion of the sensor is a lens of the camera. The aerial vehicle may include a wing, wherein the sensor is coupled to the fuselage via the wing. The sensor may be mounted to a tip of the wing. The cleaning assembly may include a fan, and a duct, wherein the duct fluidly couples the fan to the portion of the sensor. The fan may include an intake fluidly coupled to an exterior of the aerial vehicle. The cleaning assembly may include a heat sink, wherein the fan pulls air from an exterior of the aerial vehicle and the duct directs the air over the heat sink and to the portion of the sensor.

In one example, an aerial vehicle is disclosed that includes a housing, a processor received within the housing, and a heat element in electrical communication with the processor. The heat element is in fluid communication with an exterior environment and the processor is configured to: determine a power requirement to maintain a desired temperature of the heat element, and analyzing a speed of the aerial vehicle and the power to determine that ice is present on the housing. The aerial vehicle may include a wing assembly coupled to the housing and wherein the housing defines a nosecone, wherein the heat element is coupled to the nosecone.

In one example, a battery assembly is disclosed. The battery assembly includes a plurality of battery cells and a housing enclosing the plurality of battery cells, where the housing is configured to thermally couple the plurality of battery cells to enable heat transfer between the plurality of battery cells. The housing may be formed in part with an electrically conductive material. The housing may include a first tray coupled to a first end of the plurality of battery cells, and a second tray coupled to a second end of the plurality of battery cells. The first tray and the second tray may be configured to thermally couple the plurality of battery cells together. The first tray and the second tray may be formed of a metal material comprising an isolative coating. The first tray may define a shelf on an exterior of the housing to receive one or more electrical connectors. The battery assembly may include an air intake fluidly coupled to the housing, wherein the air intake defines a flow path from an environment external to the housing to an environment internal to the housing. The air intake may include an inlet having an inlet flap, and an outlet having an outlet flap, the inlet selectively closed by the inlet flap, the outlet selectively closed by the outlet flap. A movement of the inlet flap to open the inlet may move the outlet flap to open the outlet. The battery assembly may include a nonlinear cam mechanism coupling the inlet flap to the outlet flap. The nonlinear cam mechanism may include an arm of the inlet flap and a surface of the outlet flap, wherein an engagement of the arm with the surface moves the outlet flap with movement of the inlet flap. The outlet flap may be configured to open independently from the inlet flap. A docking action of an aerial vehicle may open the inlet. The inlet flap and the outlet flap may be magnetically held in closed positions. The air intake may include an inlet cavity, an outlet cavity, and a fire barrier separating the cavities. The battery assembly may include an insulator on the plurality of battery cells to provide at least one of a thermal protection or a fire protection. The insulator may be a paint. The battery assembly may include one or more rigid retainers positioned around one or more of the plurality of battery cells.

In one example, a method of containing thermal runaway for a battery is disclosed. The method includes thermally coupling an overheated battery cell to a plurality of non-overheated battery cells.

In one example, a wing assembly for an aerial vehicle is disclosed. The wing assembly may include a wing, a control surface coupled to the wing, and a motor assembly coupled to the control surface and configured to move the control surface relative to the wing. The motor assembly comprises a first motor and a second motor, where the first motor and the second motor are coupled via a linkage.

In one example, a wing assembly for an aerial vehicle is disclosed. The wing assembly includes a wing, a control surface coupled to the wing, and a motor coupled to the wing and comprising a torque shaft. The torque shaft couples the control surface to the wing and acts to rotate the control surface relative to the wing. The wing may include a wing coupling member and the control surface may include a control surface coupling member, wherein the torque shaft extends through the wing coupling member and the control surface coupling member.

In one example, an aerial vehicle is disclosed. The aerial vehicle includes a fuselage for housing electrical components for the aerial vehicle and a rigid structure coupled to the fuselage that enhances a rigidity of a portion of the aerial vehicle. The rigid structure is electrically conductive and is in electrical communication with the electrical components. The rigid structure may be configured to provide power to the electrical components. The aerial vehicle may include a docking portion coupled to the fuselage and configured to couple the aerial vehicle to a dock, wherein the rigid structure is at least partially received within the docking portion. The rigid structure may be substantially enclosed by a housing. The rigid structure may be configured to be electrically coupled to a power source outside of the aerial vehicle. A portion of the rigid structure may be exposed through a housing to electrically couple to the power source. The rigid structure may be configured to support a weight of the aerial vehicle.

In one example, a winch assembly is disclosed that includes a cable and a spool coupled to the cable. The spool includes a wrapping surface including a center portion, a first angled portion, and a second angled portion, where the cable is configured to wrap around the wrapping surface in aligned layers. The wrapping surface may passively direct the cable to wrap around the wrapping surface in aligned layers within the center portion. The winch assembly may include a motor coupled to the spool and configured to rotate the spool, wherein as the motor rotates the spool, the wrapping surface directs the cable to align in the center portion. The winch assembly may include a pulley coupled to the cable, wherein a width midpoint of the pulley is aligned with the center portion.

In one example, a parachute assembly is disclosed. The parachute assembly includes a canopy coupled to an object where the canopy is configured to increase a drag force experienced by the object and a line coupled to the canopy, where a tautness of the line determines an internal volume geometry of the canopy. The line may be configured to change a shape of the canopy. Severing the line may expand the shape of the canopy. The line may bisect a center of the canopy.

In one example, an aerial vehicle is disclosed that includes a fuselage, a parachute coupled to the fuselage, a container coupled to the fuselage, where the parachute is stored within the container, and an activation assembly coupled o the container, where the activation assembly is configured to introduce a force to expel the parachute from the container. The activation assembly may include a piston and an actuator, wherein the actuator causes the piston to move from a first position within the container to a second position within the container, and the movement of the piston expels the parachute. The aerial vehicle may include a sensor to determine a flight characteristic of the vehicle, wherein based on the sensed flight characteristic the activation assembly expels the parachute. Based on the sensed flight characteristic, the activation assembly may vary a shape of the parachute.

In one example, an aerial vehicle is disclosed that includes a pair of front motors and a pair of rear motors, where the pair of front motors is misaligned relative to the pair of rear motors.

In one example, a method of designing an aerial vehicle is disclosed that includes selecting a center of gravity for the aerial vehicle that sits within a stability bound that enables full control of the aerial upon loss of one motor.

In one example, an aerial vehicle is disclosed that includes five propellers, where the five propellers are configured to be single fault tolerance for failure of any one of the five propellers.

In addition to the exemplary aspects and embodiments described above, further aspects and embodiments will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A is a bottom isometric view of an aerial system including a first aerial vehicle and a second aerial vehicle.

FIG. 1B is a top plan view of the aerial system of FIG. 1A.

FIG. 2 is a bottom isometric view of the aerial system including the second aerial vehicle deployed from the first aerial vehicle.

FIG. 3A is a cross-section view of the aerial system taken along line 3-3 in FIG. 1B.

FIG. 3B is a cross-section view of the first aerial vehicle taken along a line similar to 3-3.

FIG. 4A is a top plan view of a chassis.

FIG. 4B is a side elevation view of the chassis of FIG. 4A.

FIG. 5A is a side isometric view of a wing assembly.

FIG. 5B is a cross-section view of the wing assembly taken along line 5B-5B in FIG. 5A.

FIG. 5C is a side isometric view of a wing assembly.

FIG. 5D is a cross-section view of the wing assembly of FIG. 5C taken along line 5D-5D in FIG. 5C.

FIG. 6A is a top isometric view of a wingtip assembly including a sensor assembly.

FIG. 6B is a cross-section view of the sensor assembly of FIG. 6A taken along line 6B-6B in FIG. 6A.

FIG. 7A is an isometric view of a battery assembly.

FIG. 7B is an exploded view of the battery assembly of FIG. 7A.

FIG. 7C is a cross-section view of the battery assembly of FIG. 7A taken along line 7C-7C in FIG. 7A.

FIG. 7D is a top isometric view of the battery assembly of FIG. 7A with selected elements hidden for clarity.

FIG. 8A is a side isometric view of a paraland assembly.

FIG. 8B is a cross-section view of the paraland assembly of FIG. 8A taken along line 8B-8B in FIG. 8A.

FIG. 9A is a schematic of a parachute in a first configuration.

FIG. 9B is a schematic of a parachute in a second configuration.

FIG. 10A is an enlarged cross-section view of the aerial vehicle taken along a similar line as shown in FIG. 3B.

FIG. 10B is an enlarged cross-section view of the aerial vehicle taken along line 10B-10B in FIG. 3B.

FIG. 10C is a front isometric view of a structural element for a docking portion.

FIG. 11A is a rear isometric view of a propeller assembly including a motor directional assembly.

FIG. 11B is a cross-section view of the propeller assembly taken along line 11B-11B.

FIG. 11C is a partial cutaway view of the propeller assembly of FIG. 11A.

FIGS. 12-13 are isometric views of an additional implementation of a battery assembly and an additional implementation of a duct assembly.

FIGS. 14-15 are cross-section views of the battery assembly and duct assembly of FIGS. 12-13.

### DETAILED DESCRIPTION

The description that follows includes example systems, methods, and apparatuses that embody various elements of the present disclosure. However, it should be understood that the described disclosure may be practiced in a variety of forms in addition to those described herein.

The examples described herein are generally directed to aerial vehicles and delivery systems that use aerial vehicles and/or various components (e.g., battery systems, docking assemblies, etc.) that can be used with aerial vehicles or with other types of vehicles, such as automobiles or other motor driven vehicles. It should be noted that while various features and components are discussed with respect to an aerial vehicle or aerial vehicle system, these features and components can be used separate from the aerial vehicle and/or in various combinations with each other. As such the discussion of any particular implementation is meant as illustrative only.

In some examples, an aerial system is disclosed that may include a first aerial vehicle (e.g., a main or carrier aerial vehicle) and a second aerial vehicle (e.g., dependent aerial vehicle). In these instances, the first aerial vehicle may act to support and/or transport the second aerial vehicle to a location and the second aerial vehicle can be deployed from the first aerial vehicle, e.g., the second aerial vehicle can be deployed from a first height and descend to a second height or location, such as to deliver a package. In some embodiments, the first aerial vehicle may be able to remain at a high location, such as by hovering, and may reduce the noise, disruption, and safety risks experienced by humans and animals on the ground or delivery location as the second vehicle may be quieter than the first aerial vehicle. Further this configuration allows both vehicles to be optimized for particular mission characteristics. For example, the first aerial vehicle can be optimized for longer flight paths and the second aerial vehicle can be optimized for an enhanced delivery experience to a human on the ground or delivery location.

In many embodiments, the second aerial vehicle may be coupled to the first aerial vehicle, e.g., by a tether, cable, or the like, but may also have separate drive abilities, allowing the second aerial vehicle to steer itself without or to supplement steering by the first aerial vehicle. In some embodiments, the second aerial vehicle may be stowed within a portion of the first aerial vehicle for a first portion of the mission and deployed and retracted for a second portion of the mission.

In some examples, the first aerial vehicle may include different flight assemblies enabling different types of flight. For example, the first aerial vehicle may include fixed wings and a cruise propeller configured to forward or cruise flight motion and may also include one or more propeller assemblies configured for hover or similar motion. In this example, the first aerial vehicle may be configured to switch between different flight configuration based on the desired motion and/or travel distance, e.g., the fixed wing and a cruise oriented propeller can be used to travel longer distances whereas hover configured propeller assemblies can be used to remain substantially fixed in a location or descend and/or rise vertically.

In one example, the first aerial vehicle may include a propeller assembly or a motor assembly configured to be coupled to a propeller configured to articulate or move relative to a fuselage of the first aerial vehicle. This allows the propeller assembly, which may be a rear or tail propeller assembly, to propel the aerial vehicle forward during a cruise motion (e.g., fixed wing flight assembly) and then move to a different position to act as a hover or stationary flight propeller. Such movement and orientation control may help to define a desired center of gravity for the aerial vehicle, as well as help to generate a fault tolerance for the aerial vehicle.

In one example, the movable propeller assembly is configured as a tail propeller assembly and is coupled to a tail of the aerial vehicle and may include one or more motors to move a propeller in one or more degrees of freedom or along one or more axes (e.g., to change a roll and pitch configuration of the propeller). In one embodiment, the propeller assembly may include a first motor assembly to move the propeller along one axis and a second motor assembly to move the propeller along a second axis, such that movement of both the first and second motor assemblies can vary a placement of the propeller in two degrees of freedom (e.g., roll and pitch). In this embodiment, propeller assembly may include at least one gear assembly forming a portion of the first and/or second motor assemblies. The gear assembly may include a planetary gear arrangement and include a sun gear configured to allow one or more wires, cables, or other components to pass therethrough, eliminating the need for extra space around the gear assembly and providing a more compact configuration and better protection for these components. In another embodiment, the propeller assembly may be mounted on an angled axis, e.g., a 45 degree axis, and a single motor assembly may be configured to move the propeller, resulting in displacement along two axes from a single degree of freedom.

In examples including a movable or articulating propeller, the propeller assembly may be configured or movable to allow different types of flight, as well as adjust or counter forces during transitions between forward and hover flights and/or environmental characteristics (e.g., wind gusts) that may occur. For example, the tail propeller may be configured to move during descent of the second aerial vehicle in light of cross winds and/or gusts to help stabilize the movement of the second aerial vehicle to a delivery location. The movability of the propeller assembly also may allow the propeller to counteract failure of another of the propellers.

The aerial vehicle may include a propeller mounting assembly that may include one or more booms extending from the fuselage and/or wings of the aerial vehicle to support one or more propeller assemblies. In one embodiment, the one or more booms are configured to position different propellers assemblies (e.g., front and rear propeller assemblies) at different locations relative to the fuselage to help stabilize the vehicle and define a desired stability bound or the like for the vehicle. For example, the booms may be configured to position the forward and rear propeller assemblies to generate centers of lift sufficient to (along with the tail propeller) define a pentagram which may ensure control of the aerial vehicle in multiple configurations (such as a fault in one of the propeller assemblies).

The length and positioning of the booms may help to define a desired center of gravity for the aerial vehicle, as well as generate a fault tolerance for the aerial vehicle. For example, the positioning and length of the booms may be selected to enable safer, more reliable and steady flight in the event of failure of a propeller assembly by counteracting lift and other forces experienced by the vehicle, e.g., to define a lift pentagram configuration. In one embodiment, the aerial vehicle may include two forwardly extending booms and two rearwardly extending booms, where both sets of booms may be coupled to and extended from the wings. In this embodiment, the forwardly extending booms may curve inwards (e.g., towards the fuselage) as they extend towards the front end or nose of the fuselage and the rearwardly extending booms may curve slightly away from the fuselage. In these examples, the forwardly extending booms may have a longer length than the rearwardly extending booms, with the shape, curvature, and length being dependent on characteristics of the aerial vehicle (e.g., weight, flight assemblies, and the like). In one example, the curvature of the booms may further help in reducing drag for the vehicle.

In various configurations, the dynamic configurability of the aerial vehicle (e.g., by modifying an orientation of the one or more propellers as well as the static placement of non-movable propellers) helps to ensure full control of the vehicle in a variety of different conditions, including both environmental configurations (e.g., cross winds, gusts, and the like) and vehicle conditions (e.g., propeller/motor failure). Such dynamic configurability not only makes the aerial vehicle more reliable and safer as compared to conventional aerial vehicles, but also helps to ensure fleet reliability and safety.

In some embodiments, the aerial vehicle may include a monolithically formed chassis that may be coupled to or form a portion of the fuselage and/or wing. The chassis may be configured as a single component and may include wing portions and/or boom portions formed therewith. In this manner, the chassis may form a continuous wall that extends around a perimeter to define the shape of the chassis. The chassis may form a structural component to support the fuselage and various components of the aerial vehicle. Additionally, in instances where vehicle weight is important, the chassis may be at least partially or completely hollow and/or formed of a light weight but strong material, such as carbon fiber. The chassis may also define one or more coupling interfaces configured to receive fasteners or otherwise couple components thereto, e.g., propeller assemblies, wings, etc. can be coupled thereto.

The aerial vehicle may include a wing assembly that includes a wing with one or more control surfaces coupled thereto. A motor assembly may be coupled to the control surface and configured to move the control surface relative to the wing, where the motor assembly includes first and second motors coupled via a linkage. The linkage allows movement of the control surface in the event of a failure of one of the motors and prevents a free surface (which could be susceptible to flutter), in the event of a motor failure.

In some embodiments, the aerial vehicle may include one or more sensors that can provide information regarding the environment and/or aerial vehicle. In these embodiments, the aerial vehicle may include an assembly for helping to remove obstructions (e.g., debris or fluid) from the sensing surface and/or remove heat from the sensor. In one example, the sensor is a camera and the cleaning assembly is configured to direct a stream of air over a portion of the camera, such as the lens, to remove debris and fluid. In one example, the air is pulled in from an external environment via a fan. In these instances, the fan is in fluid communication with a duct that directs the air to the sensing surface (e.g., lens). The duct may also be configured to direct the air over one or more heat sinks to additionally cool components of the aerial vehicle (which may be separate from or coupled to the sensing assembly). For example, the duct may direct air over a heat sink coupled to a light assembly (e.g., flight safety lights, navigation lights, or the like).

The aerial vehicle may include an ice detection assembly that may include a heat element in fluid communication with an exterior of the environment. For example, the ice detection assembly may define a duct or passageway coupled to or integrated with fuselage (e.g., on a nose of the fuselage) that directs air towards the heat element. Utilizing information from the vehicle, such as flight speed and a power to the heat element to heat the element to a temperature, the ice detection assembly can determine whether ice is present and/or other environmental characteristics.

A battery assembly can be used with the aerial vehicle or other vehicles. The battery assembly is configured to enhance operational safety and reliability by reducing instances of thermal runaway, e.g., prevent or limit one battery cell failure from causing additional battery cells to fail. In one example, the battery assembly is configured to thermally couple groups of cells together and distribute heat from a first cell (e.g., due to an explosion or fire within the first cell) to a group of cells such that no single cell gets too hot and propagates failure beyond the initial cell. In one embodiment, the battery assembly may include a thermally conductive housing that transports heat from one or more cells across the cell array. In one example, the thermally conductive housing is also configured to be light weight and may include an aluminum tray (or other material with high thermal conductivity, low mass, and structural strength) that receives or otherwise couples to the battery cells. The tray may be coated with an insulator, such as an insulative coating (e.g., foam or paint), that allows thermal conductivity without electrical conductivity across the cells. The tray may define a bottom shelf (e.g., on an exterior of the battery housing) to receive one or more electrical connectors. In some embodiments the battery cells may also include retainers positioned over a sidewall of one or more cells to help prevent rupture of the cell sidewall. For example, a rigid ring, such as a stainless steel ring, may be received around the cells. The rigid ring may also be integrated into the heat spreading structure (e.g., one or both of the trays).

The battery assembly may include a duct assembly, such as to direct or otherwise allow air flow to or around the battery cells (e.g., to heat or cool the battery assembly as desired). The duct assembly may include an inlet and an outlet that are selectively opened or closed. For example, a docking action of the aerial vehicle may open the inlet and outlet to direct air flow to the battery. Opening the inlet may cause the outlet to open, such as via a nonlinear cam-type mechanism between an inlet flap and an outlet flap. The inlet and outlet flaps may be held shut using magnets or another releasable securement. In examples, the outlet may open independently from the inlet, such as to allow the battery assembly to vent or burb during operation (e.g., to vent gases produced by a thermal runaway event). One or more barriers may separate inlet and outlet cavities of the duct assembly. For example, a first, fire barrier may be positioned near the inlet and outlet, such as to safeguard the duct assembly from hot material ejected from the battery during a thermal runaway event. A second, filter barrier may surround the cell array, such as to filter debris (e.g., ejected battery material) while allowing air to flow from the inlet to the outlet. Securement of the second barrier may allow the second barrier to expand during temperature fluctuations while maintaining integrity of the barrier's filtering functionality.

In embodiments where the aerial vehicle may form part of an aerial system and may include the second aerial vehicle, the second aerial vehicle may be configured to nest within a portion of the first aerial vehicle. In one embodiment, the second aerial vehicle may seat within a cavity formed within the fuselage of the first aerial vehicle and the bottom surface of the second aerial vehicle may form a portion of an outer surface of the first aerial vehicle. Such a configuration helps to allow the second aerial vehicle to deploy from the first aerial vehicle, without having to worry about obstructions or the like, e.g., the second aerial vehicle can drop out of the bottom of the fuselage.

In some embodiments, a tether or cable may extend between a first anchor point on the first aerial vehicle and a second anchor point on the second aerial vehicle. The aerial system can be configured such that various centers of gravity (CGs) or center of masses are aligned with one another to help balance the system. For example, a CG of the first aerial vehicle may be aligned with a CG of the second aerial vehicle. A spooling or tether point, such as a point between the first and second anchor points, may also be aligned with the two CGs, which further helps to ensure stable flight and control of the aerial vehicle, such as during transitions between forward flight and hover, as well as during deployment and retracting of the second aerial vehicle.

In various implementations, a payload (such as a payload positioned within in a payload receptacle, such as the second aerial vehicle) may be arranged on the shared center of gravity, which helps to limit CG shifts based on pre and post-delivery mass changes (e.g., before and after the payload mass is removed from the second aerial vehicle). The aligned or co-located CGs also helps to minimize line tension induced moments that are transferred to the first aerial vehicle. For example, if the second aerial vehicle and tether were attached at a location aft or otherwise unaligned with the first aerial vehicle CG, as the second aerial vehicle created tension in the tether as it was deployed, the tension would cause the first aerial vehicle CG to be pulled down aft of the first aerial vehicle CG, creating a nose-up pitching moment in the first aerial vehicle that would need to be corrected in order for the first aerial vehicle to remain stable (e.g., level). Co-locating the CGs helps to reduce or eliminate such issues, requiring less vehicle stability corrections during deployment of the second aerial vehicle.

A winching assembly may be coupled to the first aerial vehicle and configured to retract or spool the tether. The winch assembly may include a pulley and a spool, which are arranged to have a minimized fleet angle, e.g., an angle from a centerline of the pulley to the outer perimeter or edges of the spool. In some embodiments, the winch assembly may further be comprised to ensure even wrapping of the tether around the spool. For example, the spool may include an angled geometry on the wrapping or spooling surface that is angled downwards and forms a U or V shape, where a bottom of the center surface has a width slightly larger or the same as a width of the tether, preventing multiple layers of the tether from seating within the bottom at the same time. Due to the downward angle, as the spool rotates and the tether wraps over itself, the force of the weight of the tether forces the tether downward into the bottom of the wrapping surface.

The aerial vehicle may include a parachute assembly that may include a parachute and an activation assembly to activate the parachute. The parachute may include a canopy coupled to the fuselage or other portion of the aerial vehicle, such as through one or more ropes or cables. The canopy may include two configurations where the two configurations have different interior volumes of the canopy. In a first configuration, the canopy be arranged in a substantially hemispherical shape and in a second configuration, an apex of the canopy may be pulled down to define a substantially half-toroid shape. Selecting between canopy configurations allows optimization of the parachute opening distances and loads based on flight conditions at parachute deployment. In one example, a line is coupled to the canopy and configured to transition the canopy between the two configurations. For example, the line can be coupled to a center area of the canopy and when taut, the canopy may be in the second configuration, but introducing a slack into the line (e.g., by spooling the line or cutting the line), the canopy can transition to the first configuration. Similarly, by transition the line from slack to taut, the canopy can transition from the first configuration to the second configuration.

The aerial vehicle may further include an activation assembly to activate or deploy the parachute. In some examples, the parachute may be stored within the fuselage of the vehicle, such as within a container or can, and the activation assembly is configured to introduce an expulsion force to the parachute to expel the parachute from the can. In one embodiment, a piston is coupled to the container and is activated by an actuator (e.g., explosive), that introduces a force on the piston and the piston moves within the container to expel the parachute. Optionally, the parachute may be wrapped or include a rigid member, such as a sleeve, which helps to ensure that the flexible parachute is expelled by the force and does not act to absorb a substantial portion of the force. The rigid member may also be configured to puncture a seal or lid on the assembly to release the parachute.

The aerial vehicle may include a docking and/or charging structure, which may be in the form of a fin or other element, that extends outwards from the fuselage. In one example, the docking structure may include a rigid structure that enhances rigidity of the docking structure. The rigid structure can be configured to both impart rigidity to the docking structure and transmit power to electrical components within the aerial vehicle. In one example, the rigid structure may be a metal element and be configured to electrically couple the electrical components within the aerial vehicle to a power supply within a dock station. The docking structure may include an outer enclosure or housing that may at least partially enclose the rigid member and in these instances may include apertures or pins to define a connection pathway to enable the connection between the dock and the rigid structure.

In some embodiments, the docking structure may extend from a top portion of the fuselage to allow the aerial vehicle to dock or stow from a top down configuration. For example, the docking structure may support a weight of the aerial vehicle, allowing a clamp or other structure within a dock to claim the docking structure and support the vehicle, e.g., the vehicle can “hang” from the bottom of the dock. This allows a top docking configuration, making it easier for the vehicle to dock in almost any weather and reducing the impact of debris and fluid on the docking structures. For example, the aerial vehicle can align underneath a dock and have a clamping structure grab the docking structure, eliminating the need for the aerial vehicle to accurate align within an enclosed dock, prevent damage to the other flight assemblies (e.g., wings or propellers) that may otherwise have to be inserted with a garage or other housing.

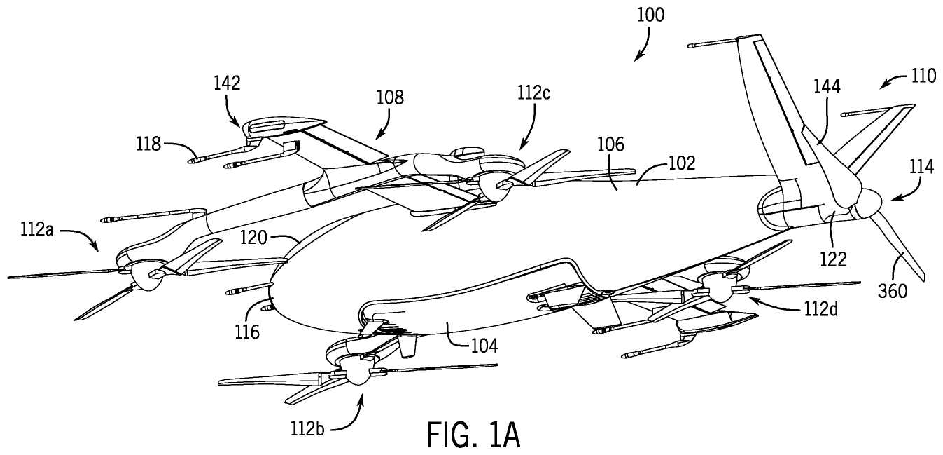

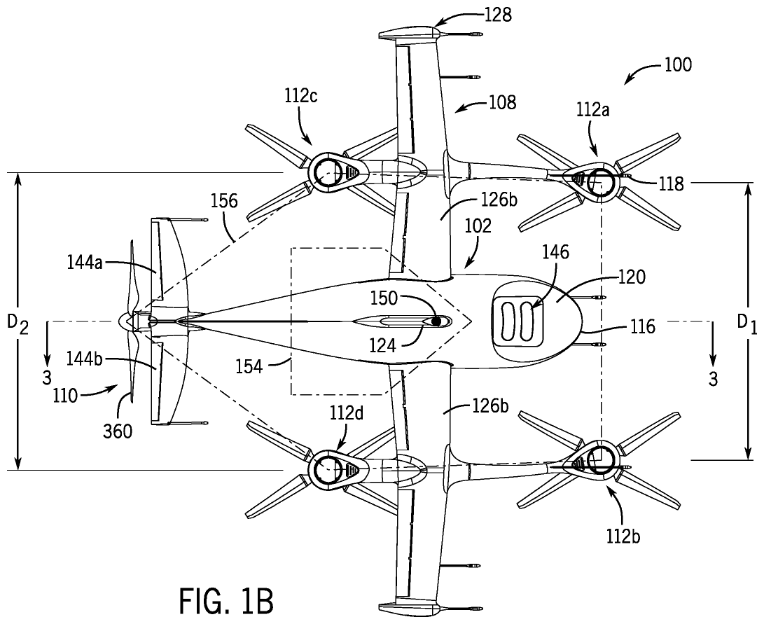

Turning to the figures, an example of an aerial system will now be discussed in more detail. FIGS. 1A-3B illustrate various views of an aerial system 100. The aerial system 100 may include a first aerial vehicle 102 or main aerial vehicle and a second aerial vehicle 104 or dependent aerial vehicle that may be releasably coupled or associated with the first aerial vehicle 104. Examples of the second aerial vehicle may be found in International Patent Application No. ______ titled “Autonomous Delivery Vehicle and System” (Attorney Docket No. P308478.WO.01), the disclosure of which is hereby incorporated by reference. In one example, the first aerial vehicle 102 may be configured to transport or support the second aerial vehicle 104 for at least a portion of a mission. For example, the first aerial vehicle 102 may include a vehicle compartment 130 defined within a fuselage 106 to receive a portion of the second aerial vehicle 104. In some embodiments, the second aerial vehicle 104 may nest within or be positioned within the first aerial vehicle 102 such that the second aerial vehicle 104 may form a portion of an outer surface of the fuselage 106 (e.g., a bottom of the second aerial vehicle 104 may be exposed to the environment during flight). In other embodiments, however, the second aerial vehicle 104 may be completely received within the fuselage 106.

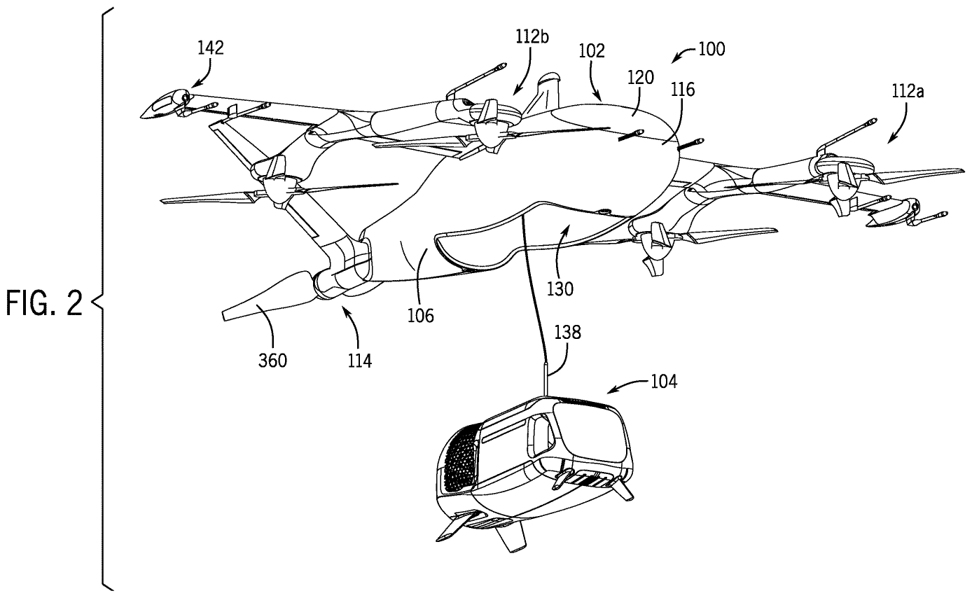

The second aerial vehicle 104 may be deployed from the first aerial vehicle 102 to complete another portion of a mission. In one example, the first aerial vehicle 102 may be configured to fly in a first configuration (e.g., in a cruise mode) to reach a delivery area and the second aerial vehicle 104 may be deployed to extend downwards from the first aerial vehicle 104 to complete delivery of a payload to a particular delivery location within the delivery area. In various embodiments, the second aerial vehicle 104 may be coupled to the first aerial vehicle 102 (such as via a tether 138, see FIG. 2) and may also include drive components to allow the second aerial vehicle 104 to act against forces (such as wind) and/or accurately land or deliver the payload to the delivery location.

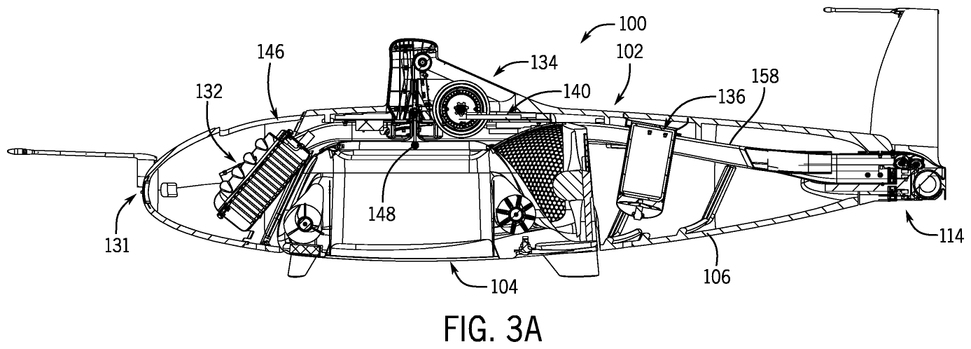

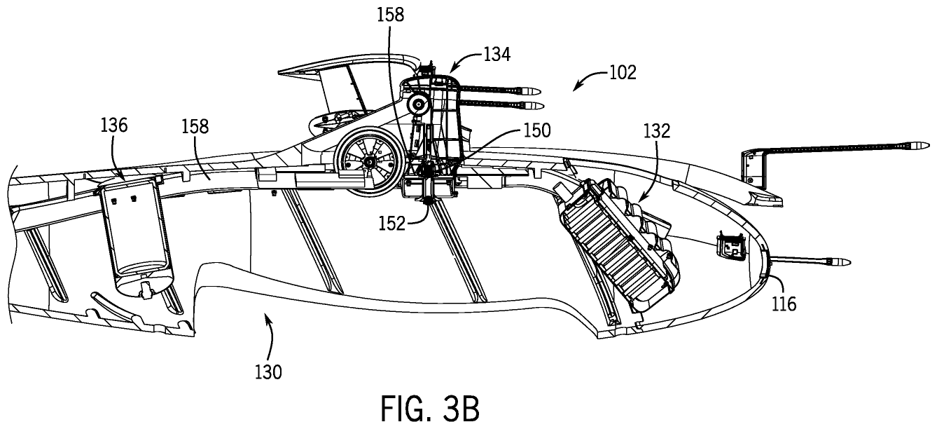

With reference again to FIGS. 1A and 1B, the first aerial vehicle 102, which may also be considered the main aerial vehicle, aerial vehicle, or aircraft, may include a fuselage 106 that defines a housing or body for the aerial vehicle 102. The fuselage 106 may include a nose 116 portion forming a front end of the vehicle 102 and a tail 122 portion forming a rear end of the vehicle 102. The fuselage 106 may generally taper as it extends towards both the tail 122 and the nose 116, although in other configurations, the fuselage 106 may be differently configured. The fuselage 106 may be configured to store various components of the aerial vehicle 102 and may be configured to store a payload and/or the second aerial vehicle 104. For example, a vehicle compartment 130 may be defined as a cavity within the fuselage 106 and in some embodiments may be formed on a bottom surface of the fuselage 106 and be configured to receive the second aerial vehicle 104 therein (see, e.g., FIG. 3A shown in the second aerial vehicle 104 stored within the fuselage 106). In some instances, the fuselage 106 (and/or other components of the aerial vehicle) may also be configured to include aesthetically pleasing features and elements.

The aerial vehicle 102 may include one or more sensors that collect data to assist in the operation of the aerial vehicle 102. For example, the aerial vehicle 102 may be operated remotely or completely autonomously by detecting information regarding the environment, such as obstacles, weather information, and the like, and may include a computer 140 and/or be in communication with a processor, to allow the aerial vehicle 102 to make decisions regarding flight, docking, and landing. For example, the aerial vehicle 102 may include a plurality of sensor assembles 118, 142 that may be coupled to the fuselage 106 and/or wing assembly 108. In one embodiment, the sensor assemblies 118, 142 may include a sensor and a probe or support structure that couple the sensor to the aerial vehicle. However, in other examples, the sensors can be coupled directly to the fuselage 106 or wings. In one example, the sensor assemblies 118 are acoustic sensor assemblies and include one or more microphones and a probe coupling the microphones to the fuselage 106 or wing assembly 108. Additionally or alternatively the aerial vehicle 102 may also include vision assemblies, such as sensor assembly 142, that couples a camera or cameras to the vehicle. Examples of the sensor assembly 142 will be discussed in more detail below.

A wind screen 120 may be coupled to the nose 116 or just above the nose 116 of the fuselage 106. The wind screen 120 may be formed of an aerodynamic material and help to streamline the shape of the aerial vehicle 102. Additionally, in some embodiments, the wind screen 120 may include an aesthetic element and be configured to enhance the aesthetic appearance of the aerial vehicle 102.

The aerial vehicle 102 may include a wing assembly 108 that may include a first wing 126a and a second wing 126b that may be coupled to the fuselage 106 and configured to extend from opposite sides of the fuselage 106. The wings 126a, 126b may be fixed in position relative to the fuselage 106 and configured to enable a cruise or forward flight motion of the aerial vehicle 102. The wings 126a, 126b may be formed of a single integrated element and/or may include multiple components coupled together to define the span or length of the wings 126a, 126b.

A tail wing assembly 110 may extend from or be otherwise coupled to the tail 122 of the fuselage 106. In one embodiment, the tail wing assembly 110 may include two upwardly facing wing portions 144a, 144b that extend outwards at an angle, such as a V shape. The tail wing assembly 110 may function as a stabilizer for the aerial vehicle 102 to help stabilize the aerial vehicle 102 during flight. In one example, the tail wing assembly 110 may be arranged in a V structure to provide both horizontal and vertical stabilization, but in other embodiments may be differently configured.

The aerial vehicle 102 may also include one or more propeller assemblies 112, 114 that can act to both propel the aerial vehicle 102 in a first flight motion (e.g., forward flight) as well as a second flight motion, such as a hover position and/or multi-dimensional flight. In one example, the aerial vehicle 102 may include a main propeller assembly 112 that may include four propeller assemblies 112a, 112b, 112c, 112d (e.g., two forward propeller assemblies 112a, 112b and two rear propeller assemblies 112c, 112d), where the propeller assemblies 112a, 112b, 112c, 112d are coupled to booms or otherwise configured to be positioned spaced apart from the fuselage 106. The mounting structures of the propeller assemblies 112a, 112b, 112c, 112d will be discussed in more detail below.

A rear or tail propeller assembly 114 may be coupled to the fuselage 106, such as to the tail 122. The tail propeller assembly 114 will be discussed in more detail below, but in some configurations can propel the aerial vehicle 102 in forward flight and/or hover or multi-dimensional flight. For example, the tail propeller assembly 114 may include a propeller 360 and may be articulable or movable based on the desired flight for the aerial vehicle 102.

A docking assembly 134 may including a docking structure or fin 124 may be coupled to or extend from a top surface of the fuselage 106. The fin 124 may be configured to be received or partially inserted within a dock for the aerial vehicle. An example dock or docking structure is described in International Patent Application No. PCT/US2024/016087, titled “Docking Configurations for Aerial Vehicles,” which is incorporated by reference herein for all purposes. The fin 124 may be also be configured to receive one or more components of a coupling assembly for retracting or deploying the second aerial vehicle 104, as discussed in more detail below. For example, the fin 124 may provide a structural mounting interface for coupling the aerial vehicle 102 to a dock. When connected, the fin 124 may provide a signal pathway, such as for battery charging, flight log download/upload, preflight checks, etc. In examples, the fin 124 may house a winch assembly configured to retract and/or deploy the second aerial vehicle 104 from the aerial vehicle 102, as discussed below.

An ice detection assembly 131 (see FIG. 3A) may be included. The ice detection assembly 131 may include a heat element in fluid communication with an exterior of the fuselage 106 (e.g., via a flow tube or the like). For example, a pitot tube or dynamic port may be attached to the nosecone. The pitot tube or dynamic port may be encased in a polymer housing that is attached to a foam housing of the nosecone. In such examples, heat is intentionally not coupled from the housing to the nosecone. The ice detection assembly 131 may be configured to utilize information from the aerial vehicle 102, such as flight speed and/or power to the heat element to maintain a desired temperature of the heat element, to determine whether ice is present and/or other environmental characteristics.

With reference to FIG. 3A, in some embodiments, a computer 140 or processor or compute assembly may be included with the aerial vehicle 102. The computer 140 may include one or more processors configured to receive information (such as from the on-board and off-board sensors) and utilize the information to make decisions, such as directing the aerial vehicle 102 to fly to certain locations or the like. The computer 140 in many embodiments may also include a communication module that may allow the computer 140 receive information from off-board sources, such as flight controller, fleet management, or other devices. The computer 140 may also include location sensors (such as global positioning sensors) or the like. The computer 140 may be varied based on the type of aerial vehicle, desired missions, and the like. As such, the discussion of any particular configuration for the computer 140 is meant as illustrative only.

With reference to FIGS. 3A and 3B, a battery assembly 132 may be received within the fuselage 106. The battery assembly 132 may be in electrical communication with the computer 140, the docking assembly 134, and/or the propeller assemblies 112, 114. The battery assembly 132 is configured to provide power to the various components and may be configured to be rechargeable (e.g., via a dock or other external power source) and/or can be removable from the fuselage 106. The battery assembly 132 may also be configured to be positioned at different angles, heights, orientations, or other positions during assembly within the fuselage 106, which may allow a center of gravity (CG) of the aerial vehicle 102 to be varied as may be desired. Once positioned at a desired location, the battery assembly 132 may be secured in position. Optionally, the battery assembly 132 may include a duct assembly 146 that may be in fluid communication with an external environment, such as to allow air flow into the battery assembly 132. The duct assembly 146 may be selectively opened or closed to allow air flow when desired, e.g., may be closed during flight and opened during docking, to allow air flow into the battery assembly 132 during the docking stage. For example, the duct assembly 146 may provide two-way airflow for temperature control while the aerial vehicle 102 is docked and a seal to prevent debris interference when in flight.

With reference to FIGS. 3A and 3B, a weight and arrangement of components of the aerial vehicles 102, 104 may be configured to allow alignment of the CGs of the two vehicles 102, 104. For example, a first CG 150 for the first aerial vehicle 102 may be aligned with a second CG for the second aerial vehicle 104, when the second aerial vehicle 104 is positioned within the vehicle compartment 130. This may also be configured to align with a spool or tether location 152, to allow balancing of forces for the two vehicles 102, 104 and enable easier control and flight dynamics of the aerial system 100 in multiple configurations (e.g., a stowed configuration of the second aerial vehicle 104, a deployed configuration, and a retracting configuration). The exact position of the CG for the two vehicles 102, 104 may be varied, but may be configured to align with one another. Similarly, a payload CG may be nominally aligned with the co-located CGs to help ensure stability and reduce moment correction during deployment of the second aerial vehicle and payload delivery.

With reference to FIG. 1B, in one embodiment, the CG 150 for the first aerial vehicle 102 may be configured to be arranged so to be positioned within a pentagram 154 or lift pentagram area defined by a force pentagon 156 defined by the location of the force generators (e.g., propeller assemblies 112, 114). That is, the first CG 150 may be contained within a lift pentagram 154 (defined by the geometric arrangement, such as a pentagon, of the propeller assemblies 112, 114 and locations of lift generation) to allow controlled flight of the aerial vehicle 102. The propeller assemblies 112, 114 are arranged relative to the first CG 150 to increase the fault tolerance for the aerial vehicle 102 and accommodate a failure of one or more of the propeller assemblies 112a, 112b, 112c, 112d and/or 114. For example, a rotational axis for the propeller assemblies 112, 114 may define a center of lift for the respective propellers. By arranging the propeller assemblies 112, 114 to be spaced apart from one another in a set arrangement, a stability bound (e.g., pentagon 154) for the first aerial vehicle 102 may be defined.

More specifically, in one example, the forward propeller assemblies 112a, 112b may be spaced apart from one another by a first distance DI or may be spaced apart from respective sidewalls of the fuselage 106 by a first distance. The rear propeller assemblies 112c, 112d may be spaced apart from each other by a second distance D2 and/or may be spaced apart from respective sidewalls of the fuselage 106 by a second distance. In this configuration, DI may be larger than D2, e.g., the rear propellers 112c, 112d may be spaced closer to the fuselage than the forward propellers 112a, 112b. This distance differentiation between the forward and rear propeller assemblies may help to define the stability bound that may allow for stable control of the vehicle under multiple different flight characteristics or scenarios, such as allowing full control of the aerial vehicle even upon the loss a propeller (e.g., due to motor failure).

In various examples, an aerial vehicle can be designed to have a CG within a stability bound in order to help ensure fault tolerance of the vehicle (e.g., maintain control and/or flight abilities even in instances of motor or propeller failure) and in various conditions, such as transitioning between forward and hover modes and/or due to wind or other environmental conditions.

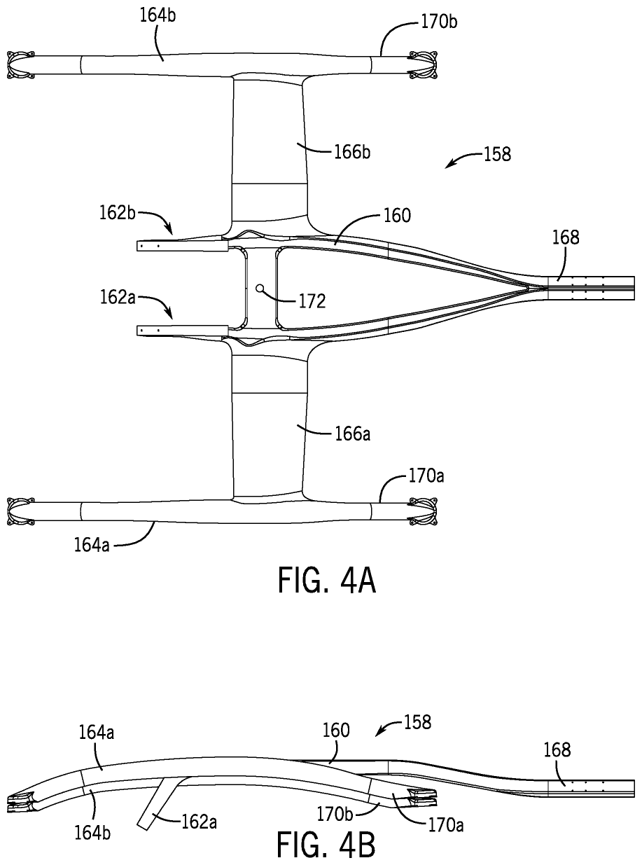

FIGS. 4A and 4B illustrate an example of a chassis 158. The chassis 158 may be coupled to the fuselage 106 and form a portion thereof and may form a supporting structure for various components of the aerial vehicle 102. For example, the chassis 158 may support the propeller assemblies 112a, 112b, 112c, 112d, 114 and/or portions of the wings 126a, 126b, as well as secure various components (e.g. the battery assembly 132) within the fuselage 106. The chassis 158 may form a rigid structure configured to support a weight of the aerial vehicle 102 as well as loads due to wind when docked. In one embodiment, the chassis 158 may be formed monolithically or otherwise formed as a single part, such as including a continuous wall that extends around a perimeter to define the shape of the chassis 158. In this manner, the chassis 158 may be easier to ship and assemble as fewer parts may be needed and may be less likely to fail as compared to multi-part formed chassis structures. Further the chassis 158 can be more easily packed and shipped as compared to other multi-component assemblies.

The chassis 158 may also be configured to be light weight and in some embodiments may be hollow or substantially hollow. In some embodiments, the chassis 158 may be formed of a composite or polymer material, such as carbon fiber. In various embodiments, the chassis 158 may define one or coupling interfaces 172, such as including fastener apertures, mounting surfaces, or the like, to receive components coupled thereto.

With continued reference to FIGS. 4A and 4B, the chassis 158 may include an anchoring portion 160 that may be configured as a center region of the aerial vehicle 102 and be configured to be coupled to multiple components. The anchoring portion 160 may be defined as a triangular shape including two tapering or angled tubes that are coupled together by a bridge portion. A first end of the anchoring portion 160, such as the intersection point of the angled tubes may define a tail portion 168 of the chassis 158.

One or more brackets 162a, 162 may extend from a front end of the anchoring portion 160 and be configured to support the battery assembly 132 or other forward anchored components. The brackets 162a, 162 may be spaced apart from one another and in some embodiments may be angled downwards and away from the anchoring portion 160.

Extending from either side of the anchoring portion 160 are wing portions 166a, 166b, which may form the wings 126a, 126 either alone or in conjunction with additional elements, such as one or more control surface or extending surfaces as discussed in more detail below. One or more booms (e.g., first, second, third, and fourth booms 164a, 164b, 170a, 170b) may extend from the wing portions 166a, 166b, such as in a generally perpendicular manner and be configured to support the propeller assemblies 112a, 112b, 112c, 112d.

The booms 164a, 164b, 170a, 170b may be configured to be curved in two directions. For example, the booms 164a, 164b, 170a, 170b may curve slightly downwards as they extend from the wing portions 166a, 166b (see FIG. 4B) to define a slight arcuate shape. Additionally, the booms 164a, 164b, 170a, 170b may be configured to curve along their length as well, e.g., curve along an axis parallel to a longitudinal axis of the fuselage 106. In one example, the front or forwardly extending booms 164a, 164b may extend from the wing portions 166a, 166b and curve inwards towards the anchor portion 160 or towards the fuselage 106 in the assembled configuration of the aerial vehicle 102. The rear or rearwardly extending booms 170 a, 170 b may be curved in an opposite direction, such as angled slightly away from the fuselage 106 or anchor portion 160. In other embodiments, the rear booms 170a, 170b may extend perpendicular from the wing portions 166a, 166b and may not curve along their length. The configuration of the booms 164a, 164b, 170a, 170b and in particular the curvature may depend on desired aero characteristics (e.g., the curvature may be selected to reduce drag) and the positioning (e.g., length and spacing of the booms) may be based on a desired CG 150 location and flight characteristics for the aerial vehicle 102.

As can be understood, the booms 164a, 164b, 164c, 164d may be configured to define the spacing for the propeller assemblies 112a, 112b, 112c, 112d. For example, the length and configuration of the booms 164a, 164b, 164c, 164d may be selected based on a desired location of a center of lift for each respective propeller assembly 112a, 112b, 112c, 112d, to define the configuration of the stability bound or pentagram 154.

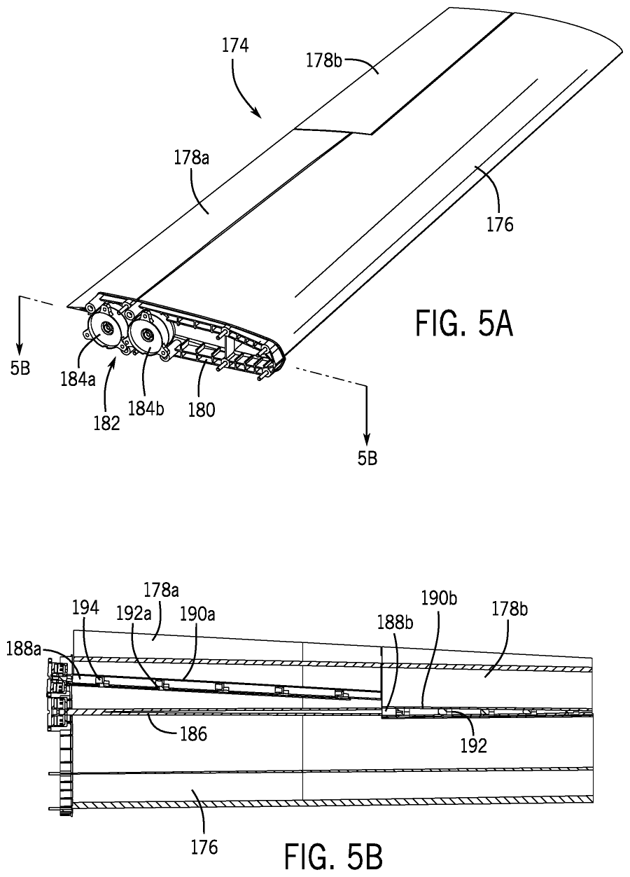

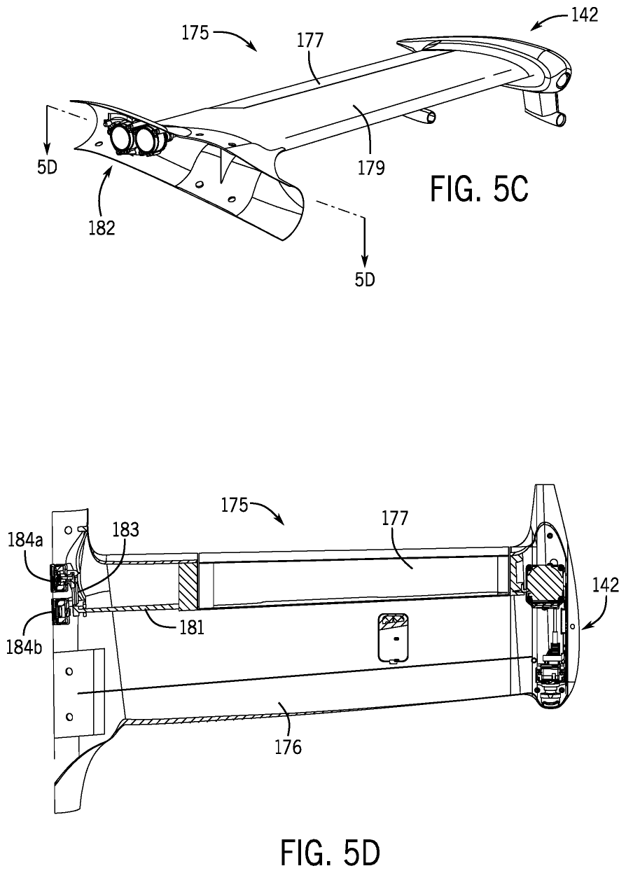

FIGS. 5A and 5B illustrate various views of a wing control assembly 174. The wing control assembly 174 is configured to mount and control movement of one or more control surfaces that couple to the wings 126a, 126b. In one example, the wing control assembly 174 may couple to the chassis 158 to secure a wing portion 176 and the control surfaces 178a, 178b to the integrally formed wing portions 166a, 166b of the chassis 158. In other examples, the wing control assembly 174 may be coupled to the fuselage 106 and/or wings 126a, 126b in different manner.

The wing portion 176 or structure forms a portion of a respective wing 126a, 126b and may be configured to remain fixed in position, e.g., may define a fixed wing portion for the aerial vehicle 102. A mounting structure 180 may be coupled to or formed with the wing portion 176 and configured to mount the wing control assembly 174 to the chassis 158. For example, the mounting structure 180 may include a recessed surface, ribs, and/or fastening tubes to receive one or more fasteners to secure everything together. The wing portion 176 may also include coupling features, such as one or more wing barrels 194 that extend from a sidewall thereof. The wing barrels 194 may be defined as cylindrical protrusions spaced part from but aligned with one another. In one embodiment, the wing portion 176 may include a plurality of wing barrels 194 that extend from a tail facing section of the wing portion 176. In embodiments where the wings 126a, 126b may include differently configured flaps 178a, 178b, the wing portion 176 may include wing barrels 194 that are arranged on different angled sections of the sidewall (see, e.g., FIG. 5B). The wing barrels 194 may have a diameter configured to receive a portion of a tube or pin therethrough, e.g., form a portion of a hinge connection for the flaps 178a, 178b.

The flaps 178a, 178b or control surfaces are configured to move relative to the wing portion 176. The flaps 178a, 178b may include a coupling feature, such as a barrel 190a, 190b that forms a portion of a hinged connection to the wing portion 176. The barrel 190a, 190b may be configured to receive a pin or other coupling assembly to secure the flaps 178b, 178b to the wing portion 176. The barrel 190a, 190b may include one or more barrel apertures 192a, 192b defined therein that may be configured to receive the wing barrels 194. In this manner, a pin can be received within the barrels 190a, 190b and secure the flaps 178a, 178b to the wing portion 176 and configure to allow the flaps 178b, 178b to rotate relative to the wing portion 176. In this manner, the fasteners for forming a portion of the hinge coupling between the wing portion 176 and the flaps 178a, 178b may be formed integrally with the respective features, omitting the need for separate fastening elements to be coupled to the components, increasing speed and ease of manufacturing, while also decreasing mass and cost. For example, this may allow portions of the wing and/or control surfaces to be injection molded or printed (e.g., 3D printed) for ease of manufacture and quick assembly.

A motor assembly 182 may be coupled to the wing portion 176 and include one or more motors 184a, 184b, which may be configured to move one or more flaps 178a, 178b. For example, the motors 184a, 184b may include a drive shaft configured to couple to a torque tube 186, 188a, 188b of the flaps 178a, 178b. The motors 184a, 184b may be configured to directly connect to the flaps 178a, 178b or may include a coupling or linkage element, such as extender torque tube 186 that connects to torque tube 188b.

FIGS. 5C and 5D illustrate another example of a wing assembly 174. As shown in FIGS. 5C and 5D, the wing assembly 174 may include a control surface 177 that may be movably connected to the wing portion 179. In this example, however, the motor assembly 182 may include a linkage 183 that couples the two motors 184a, 184b together. This coupling enables the control surface 177 to be operated (e.g., moved) even if one of the motors 184a, 184b were to fail. More particularly, if one of the two motors 184a, 184b were to fail, the other motor 184a, 184b may continue to drive the torque tube 181 via the linkage 183 while the other motor 184a, 184b may spin similar to a bearing. In this manner, each wing assembly 174 may include a single control surface that is controlled by two servo motors (motors 184a, 184b) for redundancy. Additionally, the dual motor configuration helps to prevent a motor failure from resulting in a free surface, which could be susceptible to flutter and potentially structural damage.

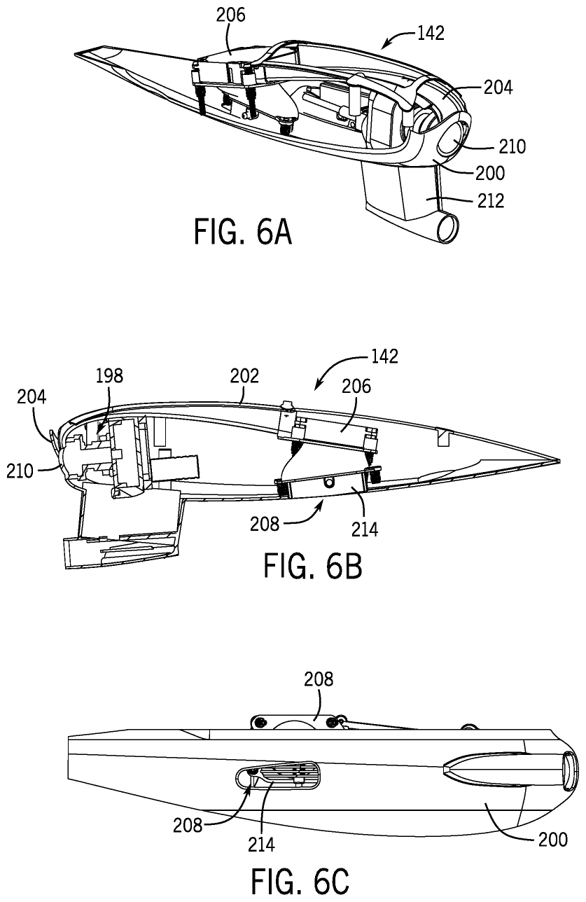

FIGS. 6A and 6B illustrate various views of a sensor assembly that may be coupled to or integrated with a wing tip assembly. The sensor assembly 142 may be configured to detect features of the environment or other data for the aerial vehicle 102. In one embodiment the sensor assembly 142 may be configured to detect visual information and include a camera 198 with a lens 210, where the lens 210 is positioned to have a field of view outside of the aerial vehicle 102. In one example, the sensor assembly 142 may be coupled to the wings 126a, 126b, but can be positioned on other areas of the aerial vehicle 102, e.g., fuselage 106.

In some embodiments, the sensor assembly 142 may be configured to direct an air stream towards a sensing surface, e.g., lens 210, to help remove debris or fluid from accumulating on the sensing surface. In these embodiments, the sensor assembly 142 may include a fan 206 fluidly coupled to a duct 204. The fan 206 may include an inlet fluidly coupled to the external environment. For example, an intake 208 or air aperture may be formed on a portion of a sensor housing 200. The duct 204 receives air from the fan 206 and is configured to direct the air over the sensing surface (e.g., lens 210). For example, the duct 204 may be fluidly coupled to the outlet of the fan 206 and form a fluid pathway to direct air from the fan 206 to the lens 210. In one example, the duct 204 may include a curved surface and mate with or couple to an interior wall of a top sensor housing 202 to form an enclosed fluid pathway.

The duct 204 may curve or otherwise be configured to direct the air at an angle (e.g., 90 degrees) relative to the lens 210 or sensing surface. This configuration helps to ensure that the air flow will force fluid and debris off of the lens 210 rather than just around or back onto the lens 210. In one example, the duct 204 may further be configured to direct downwards or towards a direction of gravity to further encourage fluid and debris to be forced off of the lens 210. In this manner, the duct 204 may include a lateral portion that extends from the fan 206 and then curves downwards as it approaches a first end of the sensor housing 200.

It should be noted that although the duct 204 is shown as being formed in part by a wall and a portion of the housing 202, in other embodiments the duct 204 may be formed by separate walls that are coupled to or positioned within the housing 200, 202.

In some embodiments, the fan 206 and duct 204 (e.g., cleaning assembly) may also be configured as a cooling assembly. For example, a heat sink 214 or other heated element may be positioned within a flow path of the fan 206 and/or duct 204. In one example, as shown in FIG. 6B, the heat sink 214 is positioned within a flow path between the intake 208 of the housing 200 before the fan 206. In this configuration, the heat sink 214 may function as a filter or screen to help prevent debris from entering into the fan 206 via the intake 208. However, in other embodiments, the heat sink 214 may be positioned between the lens 210 and the outlet of the fan 206. In various embodiments, as air is moved due to the fan 206, the air passes over the heat sink 214, to help encourage cooling of the heat sink 214, increasing the cooling efficiency. Heat sink 214 may be connected by a heat pipe to one or more other heat generating assemblies, such as a navigational light within the wing tip, helping to cool such heat generating assemblies as needed (e.g., during hover). Further, in some instances, such as when the aerial vehicle 102 is operating in cold temperatures, the heat sink 214 may help to introduce heat into the air stream, which may help de-ice or remove frozen liquid or debris from the lens 210.

It should be noted that although a heat sink 214 is shown in FIG. 6B, in other examples, the element to be cooled may be an electronic element (e.g., light emitting diode or processor) that can be cooled directly by the air stream rather than indirectly via the heat sink 214. Further, although the discussion of the sensing surface is with respect to a camera lens 210, it should be understood that other types of sensors with a sensing surface may be cleaned with the cleaning assembly discussed herein.

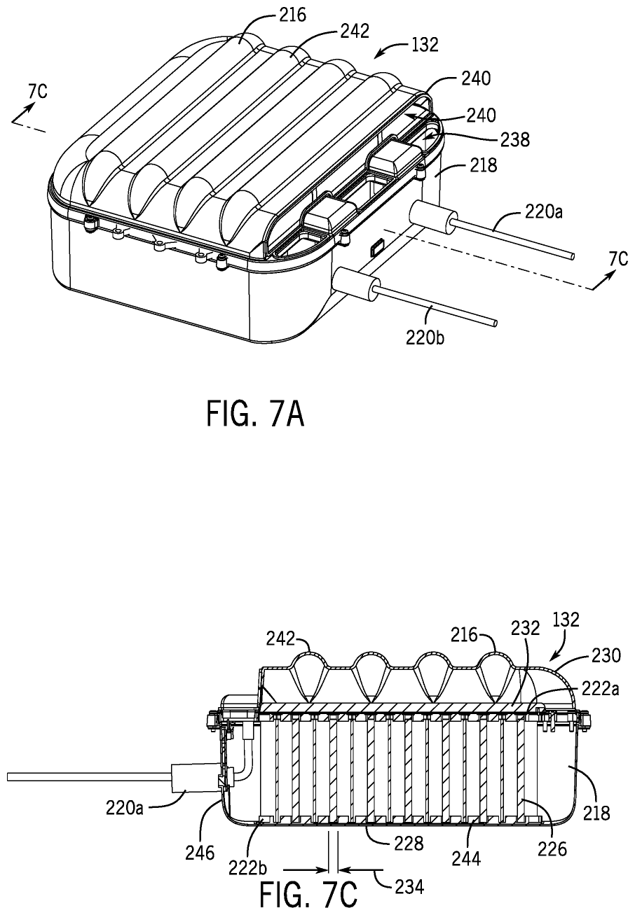

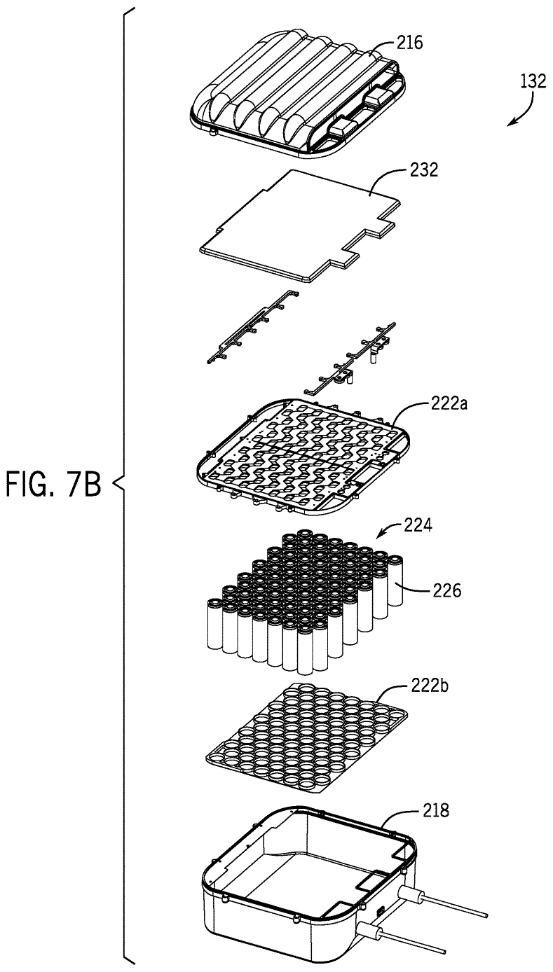

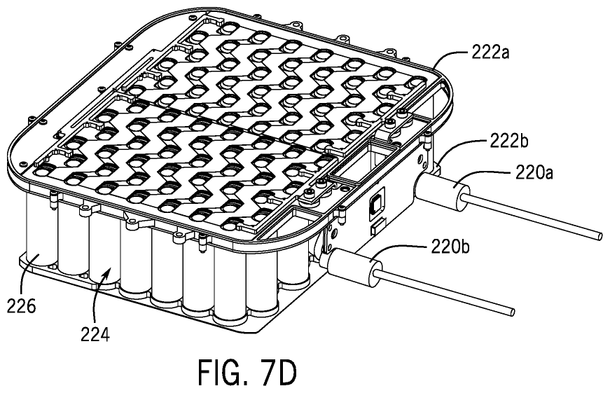

FIGS. 7A-7D illustrate various views of the battery assembly 132. The battery assembly 132 is configured to provide power to the aerial vehicle 102 and may be rechargeable and/or swappable. The battery assembly 132 may include a cell array 224 or battery pack including a plurality of battery cells 226 (e.g., lithium ion cells) that can receive electricity to store and provide power to various components. The cell array 224 may be a single cell brick constructed of multiple cells (e.g., 84 cells) arranged in a 14s6p configuration, constrained at the top and bottom by a mechanical fixture. The battery assembly 132 may include an internal printed circuit board assembly (PCBA) and current collector assembly that contains a set of sensors that measure voltage, temperature, and current. The battery cells 226 may include a sidewall, e.g., a cylindrical wall, that may receive the energy components. In some embodiments, a cell retainer 228 may be received around one or more of the battery cells 226. The cell retainer 228 in some embodiments may be a ring or other rigid element configured to introduce strength to the cell 226 wall. For example, the cell retainer 228 may be configured to reduce a likelihood of a failure of a sidewall of the cell 226 in the event that the cell 226 overheats, e.g., this may help ensure that any explosion or expelling of material occurs through the top or bottom of the cell 226, which can be more readily contained by the battery assembly 132. However, in some instances, the cells 226 may have sufficiently strong or thick sidewalls where separate cell retainers 228 may be omitted. The cell retainers 228 may be separate elements or may be integrated with other components of the battery assembly 132 (e.g., the housing or support trays discussed below).

With reference to FIGS. 7A-7C, a lid 216 may form a top portion or cover the battery assembly 132, such as being coupled to a battery housing 218 or may form a portion of the housing 218. In many embodiments, the lid 216 acts to reduce or prevent the spread of flames, such as due to an overheated or failed battery, from reaching other areas of the aerial vehicle 102.

The lid 216 may be configured to include flow apertures 236, 238 defined therein configured to fluidly couple the battery assembly 132 to a vent assembly (e.g., as part of a dock for the aerial vehicle 102) to allow the battery assembly 132 to be fluidly cooled, such as via air flow. To that end, the lid 216 may include one or more seals 240, such as gaskets or compressible material, around a perimeter of the flow apertures 236, 238 that create a seal against a thermal duct or other thermal component. The lid 216 may be configured to extend over the cell array 224 and may be configured to prevent spreading of explosions (e.g., be fire retardant and structurally strong). For example, the lid 216 may be formed of a heat resistant material, such as metal or steel, and optionally may include a coating 230 or layer that further increases the fire resistance of the lid 216. In one example, the coating 230 may be a flame retardant material applied to the interior surface of the lid 216, such as a mica inner liner. However, the coating or other layering may be varied based on the structure and material of the lid 216. The coating 230 may be electrically insulative in some examples. In such embodiments, the coating 230 may limit or prevent an electrical short, e.g., should the lid 216 or coating 230 contact the cell array 224.

In some examples, the lid 216 may further include one or more ribs 242 that may extend across at least a portion thereof. The ribs 242 act to increase the rigidity and/or strength of the lid 216. For example, in some instances, the lid 216 may be formed of a thin sheet of steel, such as under 200 μm, and the ribs 242 enhance the strength of the lid 216.

A housing 218 or receptacle may be coupled to the lid 126 and configured to receive the cell array 224. The housing 218 may be configured to support the cell array 224 as well as allow electrical connections thereto. The housing 218 may define a cavity for receiving various components of the cell battery assembly 132, e.g., the cell array 224, support trays, circuit board 246, insulation, and/or the like. The housing 218 may be coupled to one or more electrical connectors 220a, 220b that may include electrical coupling elements, such as wires (e.g., aluminum wires), that electrically connect to the cell array 224. In some examples, the electrical connectors 220a, 220b may be part of an entirely aluminum conductive path.

An insulator 232 may be included in the battery assembly 132 and configured to be positioned between the lid 216 and the cell array 224 (e.g., on the top of the cell array 224). The insulator 232 helps to prevent material from damaging other cells during thermal runaway and/or escaping from the battery assembly 132, e.g., explosive material due to a cell runaway. For example, during a cell runaway, hot and/or otherwise corrosive material may be ejected from a bad cell. The insulator 232 may provide a barrier between the ejected material and the remaining cells. The insulator 232 may be foam (e.g., a polyurethane foam) in one example. In other examples, the insulator 232 may be paint (e.g., a silicone paint). In addition to providing thermal protection (e.g., protecting adjacent cells from thermal runaway), the insulator 232 may also provide fire protection in some examples.

The battery assembly 132 may also include one or more thermal trays 222a, 222b that thermally couple various portions (e.g., different cells 226) of the cell array 224 together. The thermal trays 222a, 222b may also act to support the cells 226 and define a spacing between the cells 226. For example, the thermal trays 222a, 222b may include recesses, securing features 244, or the like, that receive or couple to an outer surface of the cells 226 to seat or hold them in position. In some embodiments, the thermal trays 222a, 222b are configured to space the cells 226 such that the cells 226 do not physically touch one another. The trays 222a, 222b may also be configured to ensure that the cells 226 are spaced to allow fluid flow (e.g., air) between the and around the cells 226 sufficient to enable cooling, such as via an HVAC system coupled to a dock. For example, the cells 226 may be spaced apart from one another by a distance of 2 to 5 mm and in some embodiments 3 mm apart, which help to ensure air flow around the cells 226 without substantially high air pressure, but without requiring excess space for the overall volume of the battery assembly 132.

The trays 222a, 222b may be formed of a thermally conductive material and configured to thermally couple different areas of the cell array 224 (e.g., cells 226 at a first end of the cell array 224 to cells 226 at a second end of the cell array 224). Additionally, the trays 222a, 222b may be configured to electrically isolate the cells 226, e.g., to reduce a short circuit between cells. In one example, the trays 222a, 222b may be formed of a thermally and electrically conductive material (e.g., metal or a composite, such as aluminum) that is then treated, coated, or otherwise configured to reduce the electrical conductivity. In one example, the trays 222a, 222b may be formed of an aluminum material coated with a powder coat that prevents or substantially reduces electrical conductivity. Such a configuration may allow the trays 222a, 222b to be machined out of a single sheet of material, which may reduce waste and costs as compared to other manufacturing techniques required by other types of thermally conductive materials. Further, rather than other materials, e.g., ceramics, that may be thermally conductive, utilizing aluminum or other light weight thermally conductive materials allows the battery assembly 132 to remain light weight and act as a structural element.

It should be noted that although two trays 222a, 222b are disclosed, in many embodiments, the battery assembly 132 may include a single tray, e.g., one of tray 222a or tray 222b. In these instances, the single tray 222a, 222b may act as the thermally conductive layer for the battery assembly 132 and be sufficient to dissipate heat across the cell array 224. However, in embodiments utilizing two trays 222a, 222b, the thermal energy may be dissipated faster, which in some implementations may be preferable.

The battery assembly 132 may be coupled together such that the cells 226 are positioned between the trays 222a, 222b. For example, the cells 226 may be positioned within or received within the securing features 244 of the trays 222a, 222b. Either the top tray 222a or the bottom tray 222b may include an opening aligned with a top or bottom of the cells 226, respectively, to allow an electrical connection thereto. The cells 226 may then be electrically coupled to the circuit board 246 and electrical connectors 220a, 220b. The assembled trays 222a, 222bn and cell array 224 may be positioned within the housing 218 (e.g., received within the compartment or cavity defined by the housing 218). The insulator 232 may be positioned on a top surface of the trays 222a, 222b to cover a top of the cells 226 (e.g., when the top portion of the top tray 222a is partially exposed for the electrical connections). The lid 216 may then be coupled to the housing 218, such that the lid 216 and housing 218 enclose the compartment of the housing 218 and the cell array 224.

In operation, preflight, the battery assembly 132 may be cooled or heated to a selected temperature (e.g., a preflight temperature) by fluidly coupling the flow apertures 236, 238 in the lid 216 to a thermal system (e.g., through the vent), such as an HVAC (e.g., one or more ducts coupled to a fan or blower). In this manner, fluid, such as air, may flow into the battery assembly 132 and into and around the cell array 224. In some examples, the housings 218 may be slightly larger than the trays 222a, 222b, allowing the fluid to flow around the sides of the cell array 224 and/or in through the openings in the top or bottom trays 222a, 222b. Due to the spacing of the cells 226 defined by the trays 222a, 222b, the pressure required by the HVAC or other flow system to circulate the fluid around individual cells 226 of the cell array 224 may be reduced. This allows the fluid to efficiently cool or heat the cells 226 to a desired temperature. In some embodiments, the cells 226 may be cooled to a lower temperature to counteract the increase of temperature during the flight, e.g., the temperature for the cooling may be selected based on an estimated flight energy expenditure, to help reduce overheating of the battery assembly 132 during flight.

During flight or use of the battery assembly 132, the cells 226 may generate energy and transfer the energy to the electrical connections 220a, 220b to power various components of the aerial vehicle 102 (e.g., propeller assemblies, sensor assemblies, and the like). In the event that one of the cells 226 experiences a thermal failure (e.g., overheats and/or explodes), the thermal energy from the cell 226 may be dissipated across multiple cells of the cell array 224 via the trays 222a, 222b. For example, if a cell 226 on a first end of the cell array 224 gets too hot, the heat will be transferred away from its adjoining neighbors to other, cooler, cells further in the array. This heat transfer helps to prevent the runaway of a single cell 226 from causing runaway of adjacent cells (e.g., prevents a full thermal runaway and failure of the battery assembly 132). Conventional battery assemblies typically use cooling plates that attempt to cool the overheating cell rather than dissipating the heat across the array. However, these types of cooling systems typically require onboard components that would substantially increase the weight of the aerial vehicle 102, which may decrease efficiency and/or impact regulations applicable to the aerial vehicle 102 (e.g., different flight classification) and therefore are not desirable for most implementations. In other words, the battery assembly 132 can address thermal runaway in a passive manner, without the need for active fluid flow or other cooling mechanisms.

In various embodiments, the aerial vehicle 102 and/or aerial vehicle 104 may include a paraland assembly 132. The paraland assembly 132 may be configured to activate a parachute to safely land and/or help reduce a velocity of the aerial vehicle 102 or aerial vehicle 104 in the event of failure (e.g., slowing landing of the aerial vehicle 102). In some configurations, the aerial vehicle 102 may be configured to have different modes of flight (e.g., forward cruise and hover) and the paraland assembly 132 may be configured to both actuate a parachute during a failure in either mode and/or vary characteristics of the activated parachute to ensure adequate speed reduction based on the flight mode. For example, the paraland assembly 132 can deploy a parachute at low altitude in hover and at cruise speeds to optimize safety during all phases of flight.

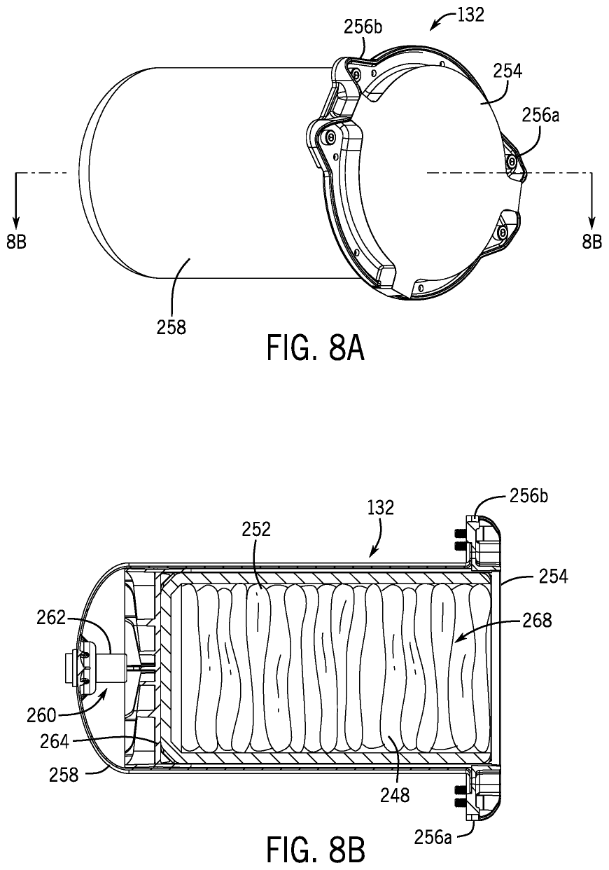

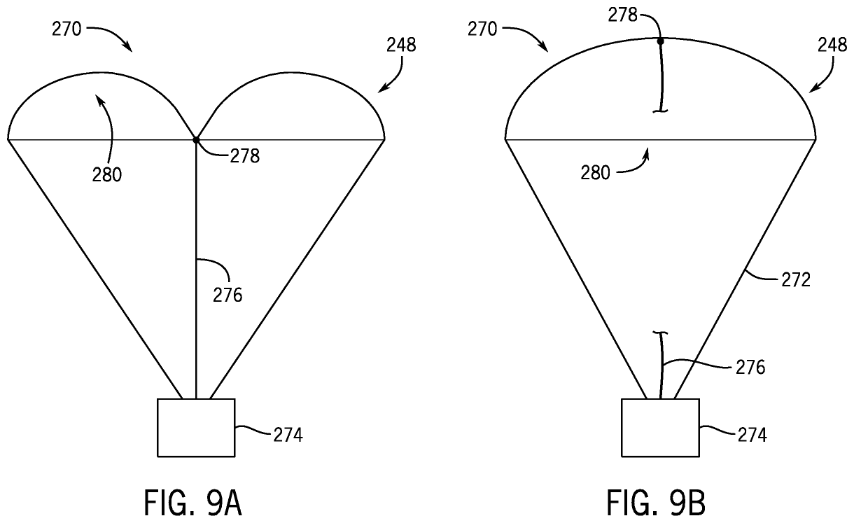

FIGS. 8A-9B illustrate various views of the paraland assembly 132. The paraland assembly 132 may include a parachute 248 (examples of which are discussed with reference to FIGS. 9A and 9B), but generally is configured to include a surface area that reduces a velocity of the aerial vehicle 102 or other element to which it is coupled. A parachute wrap 252, which may be in the form of a sleeve or cylindrical container, is configured to be received around the parachute 248. For example, the parachute 248 may be compressed into the parachute wrap 252. The parachute wrap 252 may be more rigid than a material of the parachute 248 (e.g., may not be fabric or canvas, but may be plastic) and configured to move, rather than deform, upon experiencing a compressive force, and assists in actuating the parachute 248 from the paraland assembly 132.

A parachute housing 258 is configured to receive the parachute 248 and/or wrap 252. The parachute housing 258 may define a parachute compartment 268 therein. The parachute housing 258 may be configured as a can or other structure and may be formed of a relatively rigid and strong material. In some examples, the parachute housing 258 can further act as a strengthening member for the aerial vehicle 102, e.g., act to introduce rigidity to the fuselage 106. One or more mounting brackets 256a, 256b may be defined or coupled to the parachute housing 258, e.g., may extend from a top end perimeter of an opening to the compartment 268. The brackets 256a, 256b may be a separate element forming a portion of a cap or may be integrated with the housing 258. However, the mounting brackets 256a, 256b may be positioned in different configurations depending on how and where the parachute housing 258 may be coupled to the fuselage 106, e.g., may be positioned along a sidewall of the parachute housing 258 and/or bottom, or may be omitted. In one example, the parachute housing 258 is monolithically formed from a single piece of material to ensure strength and avoid seams that introduce weakness. For example, the parachute housing 258 may be formed of a composite or metal. In instances where the housing 258 is formed of metal it may be extruded to generate the desired shape. However, in other embodiments, different configurations are envisioned.

In some embodiments, a lid or cover 254 may be coupled to the parachute housing 258 via the brackets 256a, 256b. For example, the brackets 256a, 256b may be formed as a ring that is received around the housing 258 and coupled thereto and the cover 254 may be secured (e.g., via adhesive) to the bracket ring. The cover 254 may cover the parachute compartment 268. The cover 254 may be configured to prevent debris, fluid, etc. from entering into the parachute compartment 268. The cover 254 may be releasably coupled to the parachute housing 258, e.g., to allow the parachute 248 and/or wrap 252 to disconnect the cover 254 when activated. For example, the cover 254 may be a thin sheet of material coupled via adhesive that readily decouples from the parachute housing 258. In some embodiments the cover 254 may be formed as part of the fuselage 260 (e.g., formed of a similar material as the fuselage or the like).

An activation assembly 260 may be coupled to the parachute housing 258. For example, the activation assembly 260 may be received within the parachute compartment 268, such as at a closed or bottom end of the parachute housing 258. The activation assembly 260 may be in electrical communication with one or more processors that may provide signals to the activation assembly 260 regarding whether to activate the parachute 248.

In one embodiment, the activation assembly 260 includes an actuator 262, which may include an actuator housing and an explosive, where the explosive is configured to chemically or otherwise generate an explosive force. In one example, the explosive is nitroglycerine, but in other examples, may be different types of explosives that can be selectively actuated. In other examples, the actuator 262 may be a mechanical element, such as a motor, that can generate a force or move another component.

The activation assembly 260 may also include a piston 264 or other force application member configured to be activated by the actuator 262. The piston 264 may include a diameter that spans across a width or diameter of the parachute compartment 268 and is configured to move between a first position (e.g., dormant or storage position) and to a second position (e.g., actuated or extended position). The piston 264 is also configured to introduce a compressive force on the wrap 252 to push or force the parachute 248 to move within parachute compartment 268.

Optionally, the activation assembly 260 may also include a parachute configuration assembly. As discussed in more detail below, the parachute 248 may be configured to have different surface areas or geometries based on the flight characteristics (e.g., flight speed and direction) and the activation assembly 260 may further include components configured to vary a parachute characteristic based on the same, e.g., sever a connection or change a line length, etc.

With reference to FIG. 8B, the parachute 248 may be positioned within the wrap 252, e.g., compressed into the volume defined by the wrap 252 or the wrap 252 may be extended around the outer surfaces of a folded or compressed parachute 248. The wrapped parachute 248 may then be positioned within the parachute housing 258, e.g., positioned within the parachute compartment 268. The cover 254 may then cover the opening to the parachute compartment 268 and seal the parachute 248 within the parachute housing 258. The paraland assembly 132 may then be coupled to the fuselage 106 or other area of the aerial vehicle 102.

To activate the parachute 248, the activation assembly 260 may receive an activation or failure signal from the processor (e.g., due to damage of a propeller assembly, to the fuselage 106 or the like). In embodiments where the activation assembly 260 includes the parachute configuration assembly, the activation assembly 260 may receive flight information or a configuration signal determining whether a first or second configuration of the parachute 248 should be activated. The activation assembly 260 may activate the actuator 262, e.g., activate an explosive that generates an explosive force.

The force causes the piston 264 to move from the first position within the parachute compartment 268 to the second position and the movement causes the parachute 248 to move out of the parachute compartment 268 and remove or break the cover 254. In examples including the wrap 252, the rigidity of the wrap 252 helps to ensure that the parachute 248 is moved quickly out of the parachute container 258. For example, without the wrap 252, the material of the parachute 248 may deform to absorb the force, but the rigidity of the wrap 252 helps to move the parachute 248 within and out of the parachute container 258. Once out of the parachute container 258, the parachute 248 may unfold and force open the wrap 252 or the wrap 252 may not be connected along an edge or the like and simply fall away once no longer constrained by the interior walls of the parachute compartment 268. The parachute 248 then expands and acts to reduce the velocity of the aerial vehicle 102.

As mentioned, the parachute 248 may include different configurations that can be selectively activated by the activation assembly 260. FIGS. 9A and 9B illustrate different configurations of the parachute 248. FIG. 9A illustrates a first configuration, where a canopy 270 includes a different outer or exterior surface area and internal volume 280 as compared to the second configuration of FIG. 9B. More specifically, the parachute 248 may include a canopy 270 coupled to the aerial vehicle 102, such as via at a coupling location 274, via one or more lines 272. In some examples, the lines 272 may be coupled directly to the fuselage 106, wings 126a, 126b, or other areas of the aerial vehicle 102. As such, the coupling location 274 can be positioned as desired.

The parachute 248 may also include a pull line 276 that may be coupled to the canopy 270, such as via at an anchor position 278. The pull line 276 is configured to vary the internal volume of the canopy 270. When taut the pull line 276 may pull down a top surface of the canopy 270 to create a half toroid shape with less internal volume, but when pull line 276 is severed or loose (e.g., in a slack configuration), the canopy 270 may have a full hemispherical shape and larger internal volume. The pull line 276 may be coupled at the anchor 278 to an interior surface of the canopy 270 or may be coupled to or extend around an outer surface of the canopy 270.

In some embodiments, the pull line 276 may be severed or slackened during flight velocities over a particular threshold, such as those corresponding with cruise or forward flight. This allows the canopy 270 to full expand and include a large internal volume 280, which may take longer to fully expand and reduce peak deceleration loads on the aerial vehicle 102. For lower elevations or at lower speeds, the pull line 276 may be pulled taut or uncut, to keep the smaller, half-toroid volume 280 of the canopy 270. This configuration allows the smaller internal volumes 280 to quickly fill and expand the canopy 270 portions, e.g., allow faster expansion, which decelerates the aerial vehicle 102 in a shorter distance as compared to the larger configuration, and provides safety at low altitudes. However, such rapid deceleration may create high loads at faster air speeds. At low airspeeds and altitudes, the smaller parachute configuration may slow the aerial vehicle to a lower velocity than the larger parachute configuration.

The aerial vehicle 102 may include a docking assembly 134 that assists in docking and/or landing the aerial vehicle 102, e.g., coupling to a dock, and providing power (e.g., charging) the aerial vehicle 102. In many embodiments, the aerial vehicle 102 may be configured to be docked in a top down configuration, which allows the aerial vehicle 102 to more reliably and accurately land in a variety of weather configurations. In these embodiments, the aerial vehicle 102 may include a docking portion 282 that extends from a top surface of the fuselage 106 and optionally may be coupled to the chassis 158 so as to support a weight of the aerial vehicle 102 and optionally a weight of the second aerial vehicle 104 as well (such as when the second aerial vehicle 104 is mounted within the vehicle compartment 130).

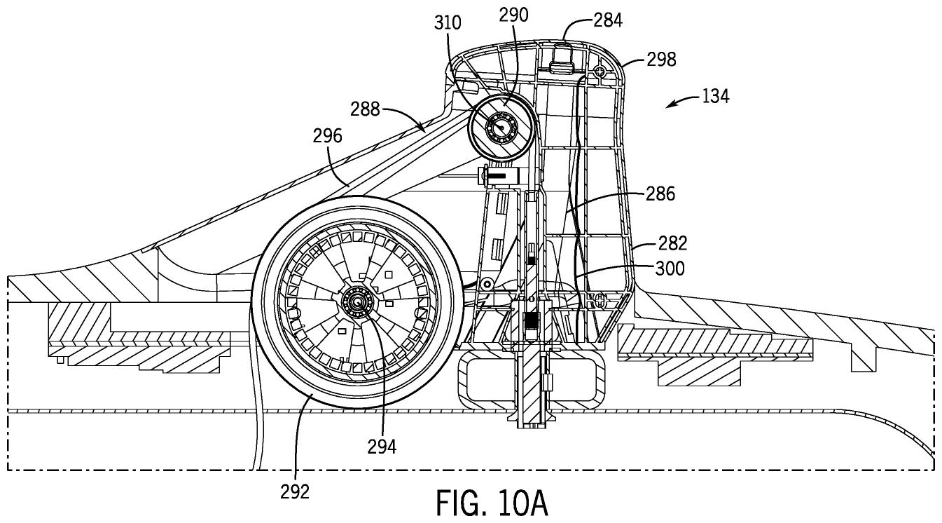

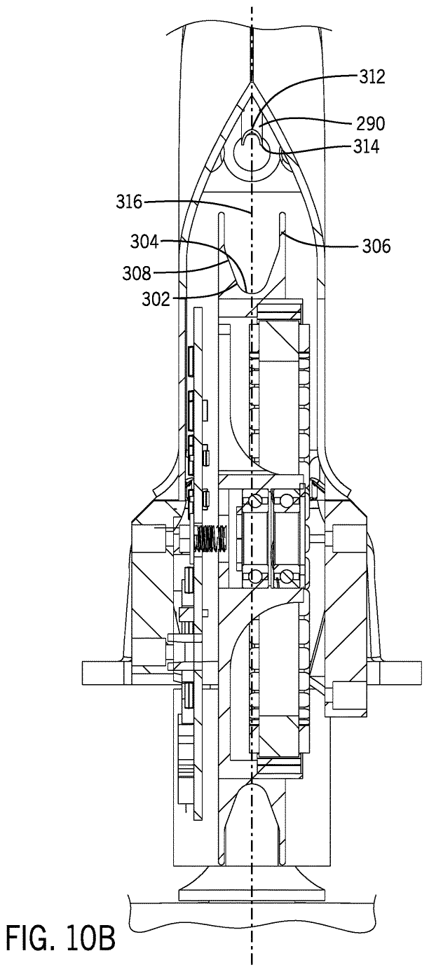

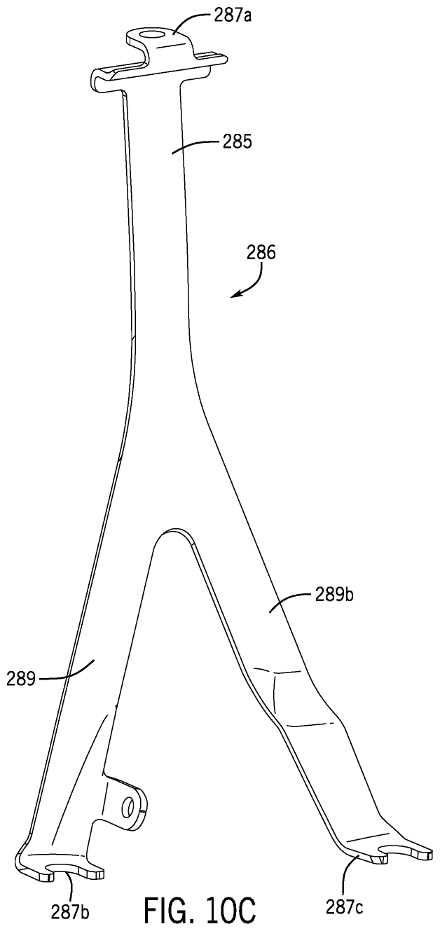

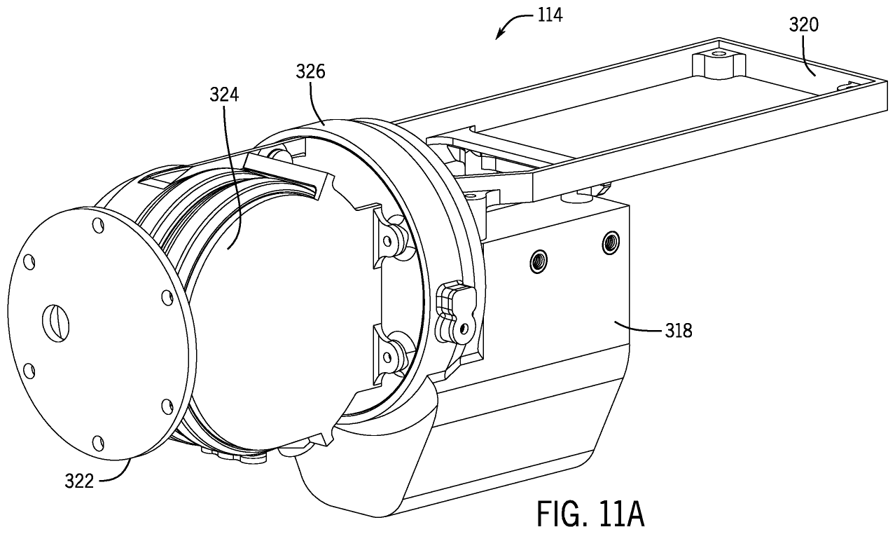

In one embodiment, a docking structure 286 or rigid member may be coupled to the chassis 158 and be configured to define a structural support member for the docking portion 282. FIG. 10C illustrates an isometric view of the docking structure 286. With reference to FIGS. 10A and 10C, the docking structure 286 may further be electrically conductive and electrically connected to one or more electrical components (e.g., battery assembly 132) to provide power (such as from a dock) to the electronic components. As one example, the docking structure 286 may be formed of a metal, such as aluminum, or other light weight, rigid, and electrically conductive material. In one example, the docking structure 286 may include two branches 289a, 289b, e.g., be formed in a Y configuration, with a stem 285 of the Y extending towards a top surface of the dock portion 282 and the branches 289a, 289b of the Y extending downwards, such as towards the chassis 158. The bottom ends of the branches 289a, 289b may be configured to couple to electronic components, such as a circuit board, or the like, to facilitate the electrical connection between the docking structure 286 and the on-board electronic components. For example, coupling brackets 287b, 287c may be formed on the bottom of the branches 289a, 289b, as well as on a top surface of the stem 285, e.g., top bracket 287a. However, in other embodiments, the docking structure 286 may be differently configured, e.g., may be differently shaped or size, but in many configurations, the docking structure 286 may have a sufficiently robust size and configuration to safely conduct large voltages therethrough.

A cap 298 may extend over the docking structure 286 and may include one or more access apertures 284 that may allow an external electrical connection (e.g., prong) to extend through the cap 298 to electrically connect with the docking structure 286. The cap 298 may also include additional apertures that may be configured to couple to other components within a dock, e.g., signaling or data connections. In these embodiments, additional communication elements, such as a wire 300, may be included with the docking assembly 134 and may be electrically coupled to one or more electrical components (e.g., onboard processor) of the aerial vehicle 102.

The cap 298 may also house portions of a winch assembly 288. The winch assembly 288 or hoist assembly is configured to retract and/or deploy the second aerial vehicle 104 from the compartment 130. The winch assembly 288 may include a pulley 290 and a spool 292. With reference to FIGS. 10A and 10B, the pulley 290 may be in the form of a wheel that rotates about an axle 310 and is configured to enable a change of direction of a tether or cable coupled to the second aerial vehicle 104. In one embodiment, the pulley 290 may include a pull surface 312 over which the tether 296 travels and may include edges 314 or sidewalls that help keep the tether 296 aligned on the pulley 290. In some embodiments, the pull surface 312 may be angled to help retain the tether 296 on the pulley 290. For example, the pull surface 312 may have a recessed channel and angled sidewalls that are angled downwards and inwards from the edges 314, e.g., forming a U or V shape on the pull surface 312. This help prevent lateral movement of the tether 296 relative to the pulley 290 and allows the pulley 290 to accurately change direction of the tether 296. For example, the pulley 290 may redirect the tether 296 by approximately 135 degrees.

The spool 292 is configured to receive the redirected tether 296 from the pulley 290 and spool 292 the tether 296 around the outer surface to store and deploy the tether 296. With reference to FIG. 10B, the spool 292 may include a wrapping surface 302 including a bottom channel 304 bordered by angled walls 308 and top edge walls 306. The bottom channel 304 is recessed and forms a bottommost area of the wrapping surface 302 and is configured to have a width substantially equal to a width of the tether 296. In this manner, a single layer of the tether 296 may fit within the bottom channel 304, which as discussed in more detail below, assists in ensuring alignment of the tether 296 as it wraps about the spool 292.

The spool 292 may further include angled walls 302 angled inwards and downwards towards a center of the bottom channel 304, to passively encourage the tether 296 to seat within the bottom channel 304 (e.g., rather than along a portion of the angled walls 302). The angled walls 308 may transition upwards to form relatively straight or planar edges 306 that act as a bumper or wall to prevent the tether 296 from sliding off of the spool 292. The edges 306 may have a height configured to be larger than a height of the wrapped layers of the tether 296 when the second aerial vehicle 104 is in the full retracted position (e.g., are configured to ensure that even when fully wrapped about the spool 292, the tether 296 is restrained in position).

With reference to FIG. 10B, when assembled, the pulley 290 and spool 292 are configured to be aligned with another such that a fleet angle (e.g., an angle between a center line of the pulley 290 pull surface 312 an angle to the outer edges of the wrapping surface 302) is minimized. For example, in one implementation, the pulley 290 and wrapping surface 302 may have the same centerline 316 or midpoint and the fleet angle may be 0 degrees. However, in other implementations, the feet angle may be differently configured. The alignment of the centerlines 316 or midpoints helps to ensure that the tether 296 remains in position and wraps in a desired layering around the spool 292.

With reference again to FIG. 10A, a drive shaft 294 may be coupled to a motor or otherwise configured to rotate, such that movement of the drive shaft 294 causes the spool 292 to rotate.

In one embodiment, the pulley 290 is coupled to the axel 310 and coupled to the docking structure 286 and/or the chassis 158. In one example, the docking structure 286 acts to couple the pulley 290 to the chassis 158, but other embodiments are envisioned. The spool 292 is coupled to the drive shaft 294, which is electrically coupled to a drive element, such as a motor, and coupled to a portion of the docking structure 286. For example, the spool 292 or components connected thereto may include one or more brackets that couple to the cap 298 or housing to the spool 292 or drive shaft 294. As can be understood, both the spool 292 and the pulley 290 are coupled to the docking assembly 134 in a manner that allows both to rotate relative thereto.

With reference to FIGS. 10A and 10B, to assist in deploying the second aerial vehicle, a locking assembly holding the second aerial vehicle 104 in a stowed position may unlock, allowing the second aerial vehicle 104 to no longer be locked in a stowed position. Due to the opening of the vehicle compartment 130 in the first aerial vehicle 102, the second aerial vehicle 104 may drop (e.g., due to the weight of the second aerial vehicle 104). This force exerts a force on the tether 296, causing pulley 290 and the spool 292 to rotate in a first direction. This rotation and further exertion of force by the second aerial vehicle 104, causes the tether 296 to unwrap from the wrapping surface 302 of the spool 292 and travel over the pull surface 312 of the pulley 290. The tether 296 may stay generally aligned within the centerline 316 and extend between the spool 292 and pulley 290, and then change direction to extend downward towards the second aerial vehicle 104.

After the second aerial vehicle 104 has been fully deployed and/or is ready to be retracted (e.g., has delivered its payload), the drive shaft 294 begins to rotate. This rotation causes the spool 292 to rotate in a second direction, away from the pulley 290. As this occurs, the tether 296, which may be anchored to the spool 292, is forced towards the spool 292. The tether 296 then travels over the pulley 290 and the pull surface 312, towards the wrapping surface 302. The tether 296 seats within the bottom channel 304 of the wrapping surface 302 and if it wraps on a portion of the angled walls 308, the force of gravity and slope of the walls 308, will encourage the tether 296 into the bottom channel 304. Because the width of the bottom channel 304 is limited, the tether 296 will force any earlier wrapped layers of the tether 296 to settle into the bottom channel 304, preventing misaligned layers, e.g., each layer may wrap directly on top of the bottom layer. The walls 306 may help ensure that the tether 296 does not get forced off of the spool 292 and continues to wrap on the wrapping surface 302.

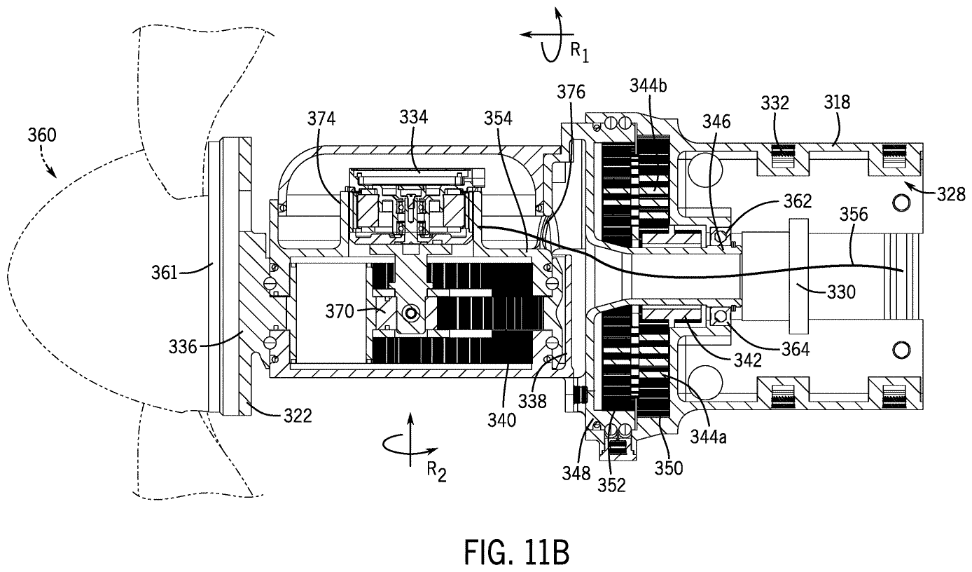

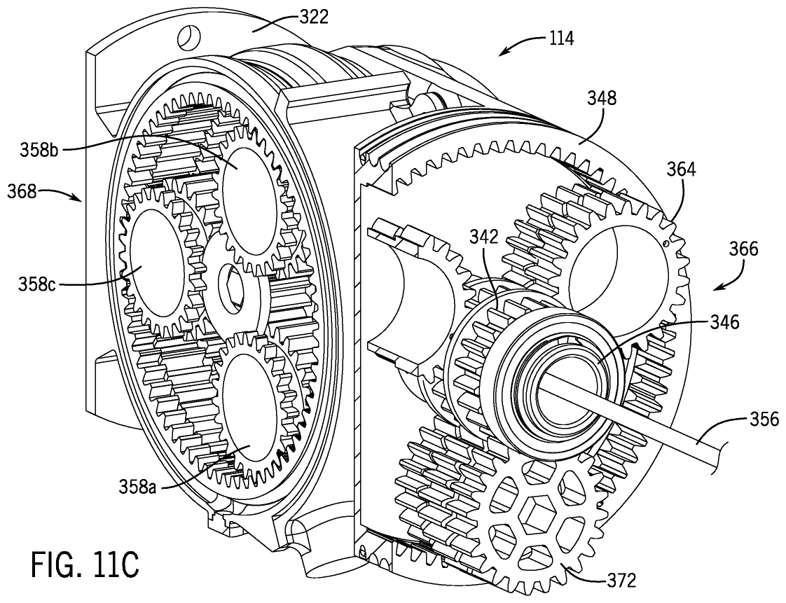

FIGS. 11A-11C illustrate various views of a propeller assembly 114 and/or propeller orientation assembly that may be used as a rear and/or articulating propeller for the aerial vehicle 102. With reference to FIGS. 11A-11C, the propeller assembly 114 or motor assembly may be configured to move a propeller 360 along one or more axes, e.g., the propeller assembly 114 may include two or more degrees of freedom that allow the propeller 360 to both transition between orientations for different modes of flight (e.g., forward flight and hover) and/or allow the propeller 360 to be moved to compensate for a failure of another propeller (e.g., one of propeller assemblies 112), and/or adjust or account for environmental forces, such as wind gusts or the like. The propeller assembly 114 may include a motor pod 361 that acts to move the propeller 360, e.g., drives the movement of the propeller 360. The motor pod 361 may be coupled between a mounting surface of the propeller assembly 114 and the propeller 360 and be configured to move with movement of the mounting surface and move the propeller 360 correspondingly.

The propeller assembly 114 may include a control board mount 320, which may be in the form of a U shaped structure, to couple to a motor control board (not shown).

A first motor housing 318 may form a portion of the propeller assembly 114 and be configured to receive various components of the propeller assembly 114 therein. Additionally, the first motor housing 318 may be configured to couple the propeller assembly 114 to the fuselage 106. The first motor housing 318 may also be coupled to the support bracket 320, e.g., one or more fasteners. The tail wings 144a, 144b may be coupled to the first motor housing 318 as well, such as via fasteners 332. In this manner, the first motor housing 318 may include mounting surfaces that may be planar or include angled surface sufficient to mount components thereto. A gear flange 326 may extend from a first end of the motor housing 318. The gear flange 326 may be defined as a generally annular member and as shown in FIG. 11B, may include a gear ring 350 including gear defined therein.

A cavity 328 is defined on the interior of the first motor housing 318 and is configured to receive one or more components of the propeller assembly 114, e.g., a motor and coupling connections. To that end, a motor flange 362 may be defined on an interior surface of the first motor housing 318 and configured to couple to a motor and may receive portions of a drive train (e.g., gear shaft) therethrough.

The propeller assembly 114 may include a first motor 330 and a second motor 334. Although in some embodiments a single motor may be utilized. The two motors 330, 334 may be configured to rotate the propeller 360 along separate rotational axes, e.g., about a first rotational axis R1 (such as to control a roll orientation) and about a second rotational axis R2 (such as to control a pitch orientation).

One or more gear configurations may be used to change the motion characteristics of the assembly different from those generated by motors 330, 334. In one example, the propeller assembly 114 may include a first gear assembly 366 for the first motor 330 and a second gear assembly 368 for the second motor 334. The two gear assemblies 366, 368 may optionally be planetary gears (e.g., including a sun gear 342, 370 and planet gears 344a, 344b, 344c, 358a, 358b, 358c, and a ring gear 354, 338). However, in other configurations, different gearing arrangements may be used (e.g., while certain planets are shown as compound gears, other configurations are envisioned). Also, as shown in FIGS. 11B and 11C, one or more of the gears may be used in a compound or dual ring configuration, e.g., to couple to different parts or extend a connection of the gearing as needed. As such, the discussion of any particular gearing arrangement is meant as illustrative only.

A gear mount 348 may be configured to couple to both gear assemblies 366, 368. The gear mount 348 may be defined as a two perpendicularly arranged receiving structures (e.g., disks) and may be configured to also form a portion of the gear assemblies 366, 368, e.g., may include teeth to form a portion of gear rings 352, 338. The gear mount 348 may include a motor mount 374 to couple to the second motor 334 and may include a gear shaft 346 to couple to the first motor 330. The gear shaft 346 may be defined as a tubular shaft or extension and may form a center of the first disc portion of the first gear assembly 366 mounting area. The gear shaft 346 may be hollow to receive components therethrough, e.g., a wire 356 and be configured to receive a portion of the gear assembly 366 (e.g., receive the first sun gear 342). The gear mount 348 may further include a wire aperture 376 to couple the passage of the gear shaft 346 to a portion of the second gear assembly 368 housing. This allows the wire 356 (or other component) to extend through the gear mount 348 to reach different compartments or areas. In one example, the wire 356 extends through the gear shaft 346 to electrically couple the second motor 334 and/or motor pod 361 to a power and/or control source, that may be positioned or include connections within other areas of the aerial vehicle 102.

In some embodiments, the first motor 330 may be offset from the first sun gear342 and so may include a drive gear 372 that couples to and drives the sun gear 342 in the first configuration. For example, a drive shaft from the first motor 330 may couple to the drive gear 372.

To assemble the propeller assembly 114, the gear shaft 346 of the gear mount 348 may be received through the motor flange 362 of the motor housing 318. Optionally, a bearing 364 may be received between the interior surface of the motor flange 362 and the gear shaft 346 to assist in the rotation of the gear shaft 346. The first motor 330 is positioned adjacent the terminal end of the gear shaft 346 and may be coupled to the first sun gear 342 via the drive gear 372. The first set of planets 344a, 344b, 344c may be mounted about the first sun gear 342 and within the rings 350, 352 formed by the motor housing 318 and the gear mount 348. The wire 356 may extend from an electrical component positioned within or coupled to the motor housing 318 and extend through the gear shaft 346 and through the wire aperture 376.

The second motor 334 may be mounted within the motor mount 374 formed in the second area of the gear mount 348. The wire 356 may electrically couple to the second motor 334. The second motor 334 may then include a drive shaft that couples to the second sun gear 370, which may be received around the drive shaft. The second set of planets 358a, 358b, 358c may be coupled to the second sun gear 370 and received within the ring defined by the propeller ring 338 and/or gear mount 348. The propeller 360 may be coupled to a motor pod 361 or assembly configured to actuate the propeller 360, where the motor pod 361 may be coupled to the mount surface 366 (e.g., via fasteners).

In operation, the first motor 330 rotates, causing the first sun gear 342 to rotate the planet gears 344a, 344b, 344c and the gear mount 348. As the propeller 360 is mounted to the gear mount 348 (via the connection of the propeller mount 322), rotation of the gear mount 348 about the first axis RI causes the propeller 360 to rotate correspondingly. Similarly, as the second motor 334 rotates the drive shaft, the second sun gear 370 rotates, causing the second set of planets 358a, 358b, 358c to rotate and move the propeller ring 338. This movement causes rotational about second axis R2. The two motors 330, 334 and gear assemblies 366, 368 are then able to rotate the propeller 360 in two degrees of freedom, e.g., about two separate axes, to cause rotation, for example, about at least two of a roll axis, a yaw axis, and a pitch axis. The axis selected for rotation may be based on the arrangement of other propellers or drive assemblies and the mounting configuration of the propeller assembly 114 relative to the aerial vehicle 102.

As mentioned, the propeller assembly 114 is configured to move the propeller 360 so as to provide two degrees of freedom (e.g., movement along two axes). In this example, the first gear assembly 366 may be driven by the first motor 330 to rotate the gear mount 348 about a first axis R1 and the second gear assembly 368 may be driven by the second motor 334 to rotate the propeller mount 322 in about a second axis R2. In some embodiments, the rotation about the axes R1 and R2 may be in either direction, but in other embodiments the rotation may be limited.

In other examples, the propeller assembly 114 may be configured to articulate or reposition the propeller 360 via a single motor, but still enable variation of both roll and pitch of the propeller 360. For example, the propeller assembly 114 may include an angled or canted plane upon which the motor and propeller are mounted. Movement of the motor then may act to

With reference to FIGS. 1A-3, the aerial system 100 may be coupled together. The second aerial vehicle 104 may be assembled and coupled together, such that the tether 138 extends from and is coupled to the top surface of the second aerial vehicle 104.

The first aerial vehicle 102 may be assembled. For example, one or more components may be coupled to the chassis 158. For example, the tail portion 168 of the chassis 158 may be coupled to motor housing 318 of the propeller assembly 114. The tail wing portions 144a, 144b may be also be coupled to the motor housing 318, such as along sidewalls of the motor housing 318.

With reference to FIG. 10A, the docking assembly 134 may be coupled to the coupling interface 172 of the chassis 158, such as by coupling the structural member 286 to the coupling interface 172 of the chassis 158. With reference again to FIGS. 3A and 4A, the battery assembly 132 may be connected to the battery brackets 162 and positioned such that the battery assembly 132 may be arranged at an angle relative to a center line of the fuselage 106. The exact orientation of the battery assembly 132 may be varied based on a desired location of a CG for the first aerial vehicle 102. The battery assembly 132 may be fluidly coupled to and aligned with the duct assembly 146.

The body portions of the fuselage 106, which may be formed of a foam or other light weight material, may be coupled to the chassis 158 and positioned around the various assemblies. For example, the body portions may include an upper foam, a lower foam, and a nose cone foam. The lower foam may be mounted to the chassis 158 (e.g., via plastic inserts and fasteners). The upper foam may datum off the lower foam and may be fastened to the lower foam (e.g., via a seatbelt system). The nose cone foam may attach to the lower foam (e.g., via interlocking teeth and shingles for alignment). The paraland assembly 132 may be coupled to the chassis 158 and/or received around the body portions of the fuselage 106.

The wing control assembly 174 may be coupled to the chassis 158 and in particular to the wing portions 166a, 166b and/or booms 164a, 164b. For example, the motor assembly 182 may be in electrical communication with an on-board computer or processor, and the control surfaces 178a, 178b may be coupled via the barrel arrangements to the wing structures 176, which may be coupled to the ends of the wing portions 166a, 166b or extend from the outer side surfaces of the booms 164a, 164b. The torque tube 186, 188 may then couple the control surfaces 178a, 178b to the wing structure 176. The sensor assemblies 142 may be coupled to either end of the wing structures 176, e.g., on the terminal edge of the wing structures 176 that extend away from the fuselage 106. In other configurations (e.g., with the wing assembly of FIGS. 5C and 5D), the wings may be coupled in a different manner.

The propeller assemblies 112a, 112b, 112c, 112d may be coupled to respective ends of the booms 164a, 164b, 170a, 170b. For example, the propeller assemblies 112a, 112b, 112c, 112d may be mounted at each end of the booms 164a, 164b, 170a, 170b.

The second aerial vehicle 104 may then be positioned within the vehicle compartment 130 and the tether 296 coupled to the docking assembly 134 (e.g., coupled to the spool 292 and pulley 290). Additional sensors, e.g., acoustic sensors 118, may be coupled to various locations along the fuselage 106 and/or other areas of the aerial vehicle 102.

In operation, the first aerial vehicle 102 may disengage from a docking station or other location, and utilizing a tail propeller assembly 114, which may be positioned in a “cruise” or forward flight configuration, may fly towards a particular location, e.g., a delivery location. Utilizing the sensor assemblies 118, 142, as well as other on-board sensors (e.g., GPS and the like), the first aerial vehicle 102 may navigate itself towards the particular location. Once at a delivery location or other set location, the first aerial vehicle 102 may arrange itself for deployment of the second aerial vehicle 104. For example, the propeller assemblies 112a, 112b, 112c, 112d may actuate and rotate to keep the first aerial vehicle 102 in a hover or stationary configuration. Optionally, the tail propeller assembly 114 may be rotated by the gear assemblies 366a, 366b to a hover configuration. Then, the docking assembly 134 may unlock and allow the second aerial vehicle 104 to deploy from the vehicle compartment 130. The vehicle compartment 130 may not include doors or other covers and so the second aerial vehicle 104 may be readily able under the force of gravity to deploy out of the vehicle compartment 130. As the second aerial vehicle 104 deploys, it may be “active” and able to drive itself, such as to counteract wind or other environmental forces it experiences as it descends to a delivery point from the aerial point of the first aerial vehicle 102. This helps to ensure that the payload (which may orientation sensitive, such as food or liquids) remains stable and in a desired orientation. The tether 296 unspools from around the spool 292 and rotates the pulley 290.

Once a payload is delivered by the second aerial vehicle 104 or the second aerial vehicle 104 is otherwise ready to be retracted, the spool 292 is powered to rotate in the opposite direction, winding the cable 296 about the winding surface. This force causes the second aerial vehicle 104 to retract and be pulled into the vehicle compartment 130. The spool 292 continues to rotate until the second aerial vehicle 104 is fully seated within the vehicle compartment 130. The second aerial vehicle 104 may have an overall body shape and geometry to allow passive assignment of the second aerial vehicle 104 within the vehicle compartment 130.

After the second aerial vehicle 104 is retracted, the tail propeller assembly 114 may be reconfigured, e.g., transitioned to a cruise mode, and the first aerial vehicle 102 may then return to a docking station or other location. If before cruise mode has been activated and/or during cruise mode, and the aerial vehicle 102 detects an issue, the paraland assembly 132 may be activated. Depending on the speed and/or altitude of the first aerial vehicle 102 during which a fault or paraland state is activated, the paraland assembly 132 may determine to vary the parachute characteristics, such as by severing or varying the line tautness of the pull line. Then, the actuator may activate the paraland assembly 132 to deploy the parachute.

If instead of a paraland mode, the first aerial vehicle 102 otherwise encounters a propeller issue, such as one of the propeller assemblies 112a, 112b, 112c, 112d going out, the tail propeller assembly 114 can articulate the rear propeller 360 to counteract the propeller issue. In such configurations, the geometric arrangement of the first aerial vehicle CG helps to ensure that the first aerial vehicle 102 remains stable and controllable, even with a changes in the center of lift arrangements.

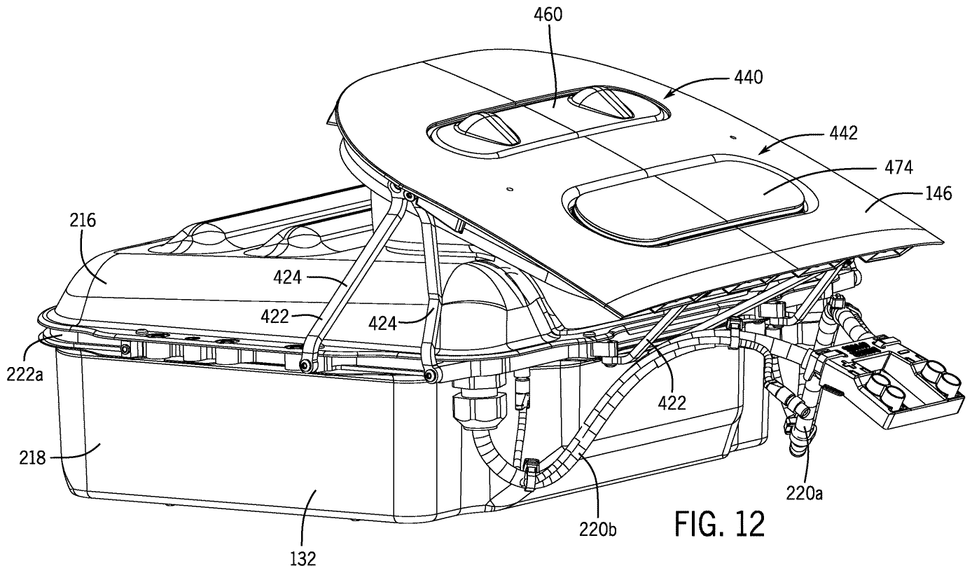

FIGS. 12-15 are various views of an additional implementation of the battery assembly 132 and duct assembly 146 (or air intake). The battery assembly 132 may be received (e.g., removably positioned or secured) within fuselage 106, such as to provide power to the various components of aerial system 100, as described herein. The duct assembly 146 may be selectively opened or closed to allow air flow into or to the battery assembly 132 when desired, e.g., closed during flight and opened during docking, as described herein.

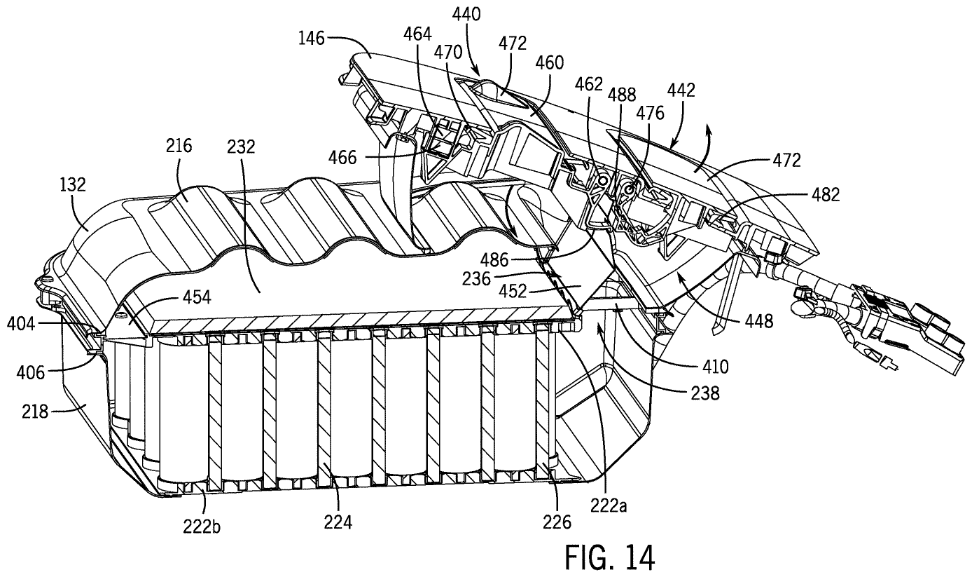

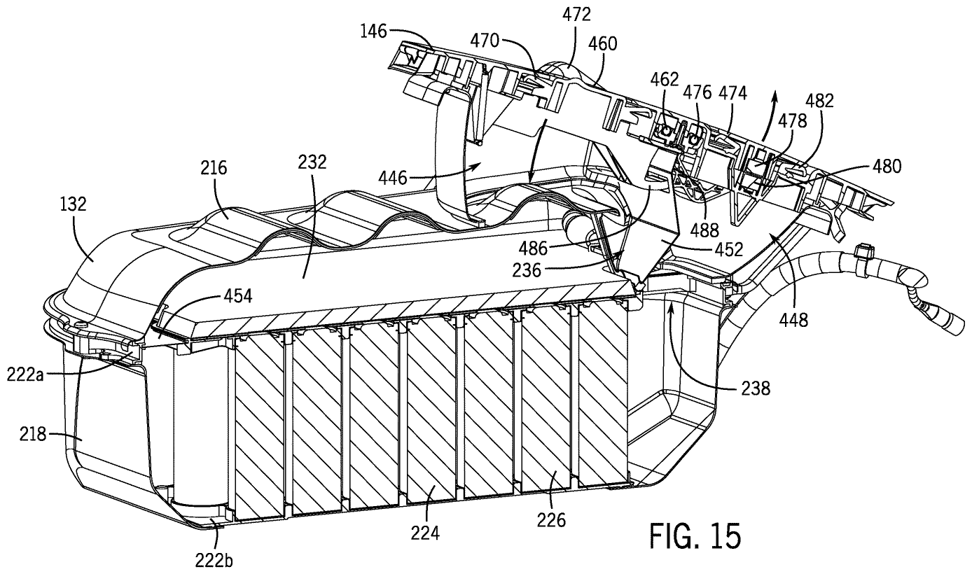

As best illustrated in FIGS. 14-15, the lid 216 may be secured to the battery housing 218 to enclose the cell array 224. The cell array 224 may include one or more thermal trays (e.g., trays 222a, 222b) structurally supporting and thermally coupling multiple cells 226 of the cell array 224. Insulator 232 may be provided at the top of the cell array 224, such as to provide thermal and/or fire protection, as described herein. For example, the top of the cell array 224 may be painted with a paint (e.g., a silicone paint, an outdoor rated silicone paint, etc.) that provides thermal and fire protection.

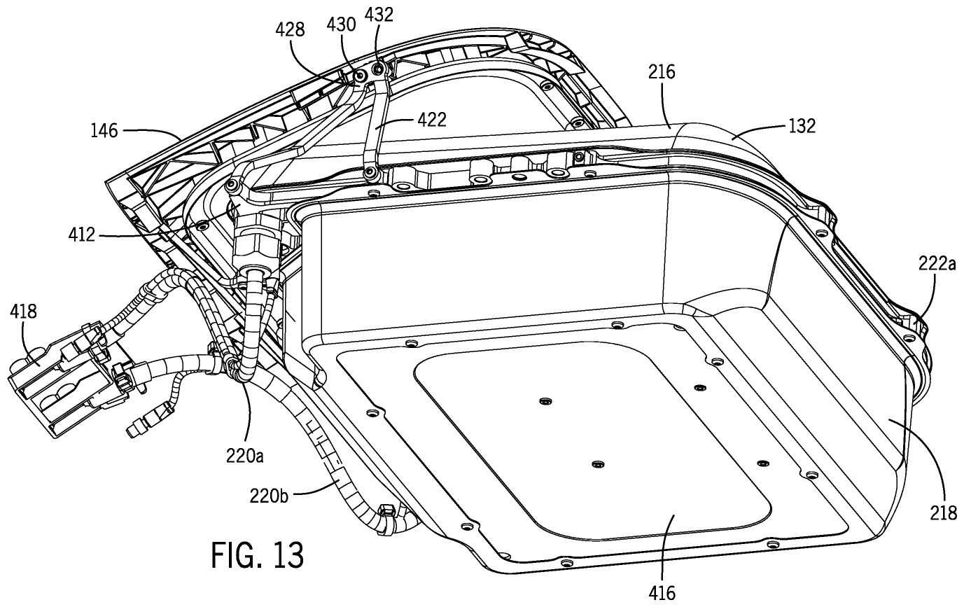

The thermal trays 222a, 222b may provide one or more structural characteristics. For example, thermal tray 222a may include integrated collars that receive respective cells of the cell array 224, such as to mechanically hold the cells in place. In examples, thermal tray 222a may be shaped to ensure heat dissipation, such as including extra material at the corners and/or edges for heat transfer. Thermal tray 222b may be shaped similarly, such as including thicker edge sections for increased thermal heat sink and a shaved down middle section for weight savings. In examples, thermal tray 222a may be positioned between the battery housing 218 and the lid 216, such as to provide structure to secure the lid 216 to the battery housing 218 and secure the cell array 224 in place. In such examples, a first seal 404 may be positioned between the tray 222a and the lid, and a second seal 406 may be positioned between the tray 222a and the battery housing 218 to seal the interior of the battery assembly 132. In some examples, the tray 222a may provide a crumple zone 410 between the cell array 224 and the battery housing 218, such as to protect the cell array 224 during impacts to the battery assembly 132. As shown in FIG. 13, the tray 222a may define a shelf 412 on the exterior of the battery housing 218. In such examples, the electrical connectors 220a, 220b may extend from the bottom of the shelf 412. In examples, the outer periphery of the tray 222a may be C-shaped (e.g., cut to include a groove along the perimeter of the tray), such as to reduce weight.

With continued reference to FIG. 13, the battery assembly 132 may include a camera mount 416. The camera mount 416 may be provided on the battery housing 218, such as on the underside of the battery housing 218. Because movement of the battery assembly 132 may be limited, such as relative to other portions of the aerial system 100, the camera mount 416 may keep an attached camera stable. In some examples, the battery assembly 132 may include a coupling 418. The coupling 418 may hold the electrical connectors 220a, 220b together, such as holding lugs of the electrical connectors 220a, 220b together but in a spaced apart relationship. The coupling 418 may provide a mechanical guide or connector for electrically connecting the battery assembly 132. For example, the coupling 418 may interface with a corresponding coupling or connector of the aerial vehicle 102.

The duct assembly 146 may be coupled to the battery assembly 132. For example, one or more brackets 422 may secure the duct assembly 146 and battery assembly 132 together. In the example illustrated in FIGS. 12-13, three brackets 422 are used to secure the duct assembly 146 and battery assembly 132 together; however, other configurations, including more or less than three brackets 422, are contemplated. Each bracket may include one or multiple legs 424 to locate the duct assembly 146 on the battery assembly 132. The brackets 422 may keep the duct assembly 146 stiff to the battery assembly 132, or vice versa, such as to counteract one or more forces experienced during docking. As best illustrated in FIG. 13, the bracket(s) 422 may include a two-part connection 428 at the duct assembly 146. The two-part connection 428 may be defined by a pair of holes (e.g., a first hole 430 and a second hole 432). The first hole 430 may receive a corresponding protrusion of the duct assembly 146, such as to locate the duct assembly 146 to the battery assembly 132 and provide a first retention of the duct assembly 146 to the bracket. The second hole 432 may receive a fastener, such as to provide a second retention of the duct assembly to the bracket for further securement.

The duct assembly 146 may include an inlet 440 and an outlet 442, such as to allow air flow into or to the battery assembly 132 when desired, e.g., closed during flight and opened during docking, as described herein. Referring to FIGS. 14-15, the inlet 440 may be fluidly coupled to the flow aperture 236 of the battery assembly 132 to define an inlet cavity 446, and the outlet 442 may be fluidly coupled to the flow aperture 238 of the battery assembly 132 to define an outlet cavity 448. In such examples, preconditioned air (e.g., cooled or heated air based on ambient temperature and battery state/temperature) may be provided to the battery assembly 132 through the inlet cavity 446. For example, air may flow through the inlet 440 when opened and into the battery assembly 132 (e.g., to the top of cell array 224) via the flow aperture 238. The outlet cavity 448 may allow air to escape. For example, escaping air may flow through the flow aperture 238 and out the outlet 442 of the duct assembly 146, such as to complete an airflow circuit when docked and/or vent the battery assembly 132 during a thermal runaway event.

One or more barriers may be positioned between the inlet cavity 446 and the outlet cavity 448. For example, the duct assembly 146 may include a first barrier 452 sealing the inlet cavity 446 from the outlet cavity 448. In examples, the first barrier 452 may provide a fire barrier. For instance, the first barrier 452 may be a metal barrier (e.g., a titanium firewall) to safeguard the duct assembly 146 from ejected material from the cell array 224 during thermal runaway. A second barrier 454 may surround the cell array 224 to separate the inlet cavity 446 and the outlet cavity 448. The second barrier 454 may be a filter that filters debris (e.g., ejected material during thermal runaway) but still allows air to flow from the inlet cavity 446 to the outlet cavity 448 (e.g., from the top of the cell array 224 to the bottom of the cell array 224). In such examples, air may flow through the inlet 440 to the flow aperture 236, around the top of the cell array 224 to the second barrier 454, through the second barrier 454 to the bottom of the cell array 224, and through the flow aperture 238 to the outlet 442. The second barrier 454 may be held in a slit provided in the thermal tray 222a. In such examples, the second barrier 454 and/or slit may be sized to allow expansion of the second barrier 454 during temperature fluctuations (e.g., to limit or prevent buckling of the filter when heated that would otherwise allow ejected material from the cell array 224 to seep through and short out the cell array 224).

The inlet 440 may be defined by an inlet flap 460. The inlet flap 460 may rotate about a first axis 462, such as between a first position sealed against the duct assembly 146 and a second position rotated into the inlet cavity 446. The inlet flap 460 may be releasably held in the first, sealed position. For example, referring to FIG. 14, the inlet flap 460 may include a first magnet or magnetic material 464 that magnetically couples with a corresponding magnet or magnetic material 466 of the duct assembly 146 in the first, sealed position. In examples, the magnets/magnetic material 464, 466 may be held in aligned cups of the inlet flap 460 and duct assembly 146. A high magnetic force may hold the inlet flap 460 shut; however, the inlet flap 460 may be easily operated after opening. For example, the magnetic force holding the inlet flap 460 closed may have a steep drop off once the inlet flap 460 is opened. In examples, a gap may be defined between the first magnet 464 and the corresponding magnet or magnetic material 466, with the gap adjustable to tailor the magnetic force.

A first seal 470 may seal the inlet flap 460 to the duct assembly 146 in the first position. The first seal 470 may be a molded rubber seal that is lightweight or easily deformable while accommodating a wide range of deformation (e.g., 1-4 mm). In examples, one or more protrusions 472 may extend from the inlet flap 460. The protrusions may be engaged when the aerial vehicle is docked to open the inlet 440. For example, docking action of the aerial vehicle to a dock may engage the protrusions to mechanically open the inlet 440. The protrusions may be shaped such that the inlet 440 is opened the same or similar amount regardless of docking position or alignment with the dock.

The outlet 442 may be defined by an outlet flap 474. The outlet flap 474 may rotate about a second axis 476, such as between a first position sealed against the duct assembly 146 and a second position rotated away from the duct assembly 146 or out of the outlet cavity 448. The outlet flap 474 may be releasably held in the first, sealed position. For example, referring to FIG. 15, the outlet flap 474 may include a second magnet or magnetic material 478 that magnetically couples with a corresponding magnet or magnetic material 480 of the duct assembly 146 in the first, sealed position. In examples, the magnets/magnetic material 478, 480 may be held in aligned cups of the outlet flap 474 and duct assembly 146. A high magnetic force may hold the outlet flap 474 shut; however, the outlet flap 474 may be easily operated after opening. For example, the magnetic force holding the outlet flap 474 closed may have a steep drop off once the outlet flap 474 is opened. In examples, a gap may be defined between the second magnet 478 and the corresponding magnet or magnetic material 480, with the gap adjustable to tailor the magnetic force. In examples, a second seal 482 may seal the outlet flap 474 to the duct assembly 146 in the first position. The second seal 482 may be a molded rubber seal that is lightweight or easily deformable while accommodating a wide range of deformation (e.g., 1-4 mm).

Movement of the inlet flap 460 may move the outlet flap 474. For example, opening the inlet flap 460 may cause the outlet flap 474 to open, and vice versa. Along these lines, the inlet flap 460 may include one or more arms 486. The arms 486 may extend towards the outlet flap 474, such as to engage a surface 488 of the outlet flap 474. The arms 486 may extend through the first barrier 452, such as through an aligned aperture defined in the first barrier 452. As the inlet flap 460 is opened, the arms 486 may move to engage the outlet flap 474. The arms 486 may ride against the surface 488 to open the outlet flap 474. As a result, pushing the inlet flap 460 down may pop the outlet flap 474 out.

In examples, a dead zone may exist between opening the inlet 440 and opening the outlet 442. The dead zone may be caused by an indirect coupling of the inlet flap 460 to the outlet flap 474. For instance, a gap may be defined between the arms 486 and the surface 488 when both the inlet flap 460 and the outlet flap 474 are closed. In such examples, the inlet flap 460 may be opened slightly without opening the outlet flap 474. Once the gap is eliminated, further opening of the inlet flap 460 may open the outlet flap 474. The indirect coupling of the inlet flap 460 to the outlet flap 474 may also allow the outlet flap 474 to open independently from the inlet flap 460. For example, the indirect coupling may allow the outlet flap 474 to open during a thermal runaway event, such as to vent produced gas, while keeping the inlet flap 460 closed.

In examples, the arms 486 and surface 488 may define a nonlinear cam-type mechanism. For instance, the engagement of the arms 486 with the surface 488 may necessitate a larger movement of the inlet flap 460 compared to the outlet flap 474, such as the inlet flap 460 opening a greater amount compared to the outlet flap 474, or vice versa.

The term aerial vehicle as used herein to include various types of aerial vehicles, such as, but not limited to, aircraft such as fixed wing, rotorcraft (e.g., helicopters, quadrotors, and so on) or combinations thereof. In other cases, at least one of the first or second vehicles may be configured to transport or move an object. For example, at least one of the first aerial vehicle or the second aerial vehicle may include a payload bay and/or include wheels, legs, tracks or the like to facilitate movement relative to a ground surface or landing surface. In some cases, the first or second vehicles may be capable of both aerial and ground movement. As such, the various vehicles and components described herein are shown in the context of an aerial vehicle system, this is for purposes of illustration, and other configurations are possible without departing from the disclosure.

Other examples and implementations are within the scope and spirit of the disclosure and appended claims. For example, features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). Further, the term “exemplary” does not mean that the described example is preferred or better than other examples.

The foregoing description, for purposes of explanation, uses specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

1. An aerial vehicle comprising:
a fuselage;
a plurality of propellers coupled to the fuselage to define a lift pentagram, wherein the lift pentagram is positioned such that a center of gravity of the aerial vehicle is positioned within the lift pentagram.

2. The aerial vehicle of claim 1, wherein each propeller of the plurality of propellers defines a lift point for the lift pentagram.

3. The aerial vehicle of claim 1, wherein the plurality of propellers and the center of gravity of the aerial vehicle are configured to enable the center of gravity of the aerial vehicle to remain within an adjusted lift geometry upon a fault for one of the propellers of the plurality of propellers.

4. The aerial vehicle of claim 1, wherein:
a first forward propeller and a second forward propeller of the plurality of propellers are spaced apart by a first distance; and
a first rear propeller and a second rear propeller of the plurality of propellers are spaced apart by a second distance, wherein the second distance is larger than the first distance.

5. The aerial vehicle of claim 4, further comprising a tail propeller, wherein the lift pentagram is defined by a center of lift generated by the first forward propeller, the second forward propeller, the first rear propeller, the second rear propeller, and the tail propeller.

6. The aerial vehicle of claim 5, wherein the tail propeller is movable relative to the fuselage for at least one of:
counteracting a loss of one of the first forward propeller, the second forward propeller, the first rear propeller, or the second rear propeller; or
maintaining a stability in transitioning between a hover mode and a cruise mode.

7. The aerial vehicle of claim 6, wherein the tail propeller is movable along at least two axes.

8. The aerial vehicle of claim 1, further comprising a plurality of booms coupled to the fuselage, wherein the plurality of propellers are coupled to respective booms of the plurality of booms.

9. The aerial vehicle of claim 8, wherein:
a first boom and a second boom of the plurality of booms extend towards a front of the fuselage and curve inwards towards the fuselage along a length.

10. The aerial vehicle of claim 8, wherein:
a third boom and a fourth boom of the plurality of booms extend towards a rear of the fuselage and are angled away from a center of the fuselage.

11.-17. (canceled)

18. An aerial vehicle comprising:
a fuselage;
a wing assembly coupled to the fuselage; and
a propeller assembly coupled to the fuselage and spaced apart from the wing assembly, wherein the propeller assembly comprises:
a propeller; and
a mounting assembly, wherein the mounting assembly moves the propeller between a first position relative to the fuselage and a second position relative to the fuselage.

19. The aerial vehicle of claim 18, wherein the mounting assembly moves the propeller to the first position for a forward flight motion and to the second position for a hovering flight motion.

20. The aerial vehicle of claim 18, wherein the mounting assembly moves the propeller to the second position to counteract environmental forces experienced on the aerial vehicle.

21. The aerial vehicle of claim 18, wherein the mounting assembly moves the propeller along a first axis and a second axis different from the first axis.

22. The aerial vehicle of claim 21, wherein the mounting assembly comprises:
a first motor to move the propeller along the first axis; and
a second motor to move the propeller along the second axis.

23. The aerial vehicle of claim 18, wherein the mounting assembly moves the propeller along a path, wherein at a first location on the path the propeller is arranged at a first yaw and a first pitch and at a second location on the path the propeller is arranged at a second yaw and a second pitch.

24. An aerial vehicle comprising:
a dynamically positionable propeller configured to be positioned at two or more positions in order to counteract forces experienced by the aerial vehicle during flight.

25. The aerial vehicle of claim 24, wherein a force experienced by the aerial vehicle comprises a force vector due to a failure of a static propeller.

26.-102. (canceled)
